(19) United States
(12) Patent Application Publication
(10) Pub. No.: US 2026/0288906 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/560,175

(22) Filed: Mar. 9, 2026

(30) Foreign Application Priority Data
Mar. 19, 2025 (JP) 2025-044947

(51) Int. Cl. G06F 18/24; G06F 16/9536; G06N 3/0475

(52) U.S. Cl. CPC G06F 18/24; G06F 16/9536; G06N 3/0475

(57) ABSTRACT

A system includes a processor that is configured to receive a dialogue history as an input and determine whether the dialogue history constitutes harassment, generate a prompt to instruct generation of visual information based on the determination, and cause visual information to be automatically generated by a generative AI model based on the prompt.

### CROSS-REFERENCE TO RELATED APPLICATION

This application is based on and claims priority under 35 USC 119 from Japanese Patent Application No. 2025-044947 filed on Mar. 19, 2025, the disclosure of which is incorporated by reference herein.

### BACKGROUND

### Technical Field

The Present Disclosure Relates to a System.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional harassment training and compliance systems largely rely on static educational materials, such as manuals, prerecorded videos, or periodic seminars, which are not tailored to the actual communication patterns of individual users. As a result, users may fail to recognize that their own dialogue, including everyday workplace communications, may constitute harassment, such as abuse of power or sexual harassment. Moreover, automatic analysis tools that merely flag text as problematic do not sufficiently convey the emotional and situational impact of the communication, and therefore provide limited support for behavioral change. There is therefore a need for a system that can automatically determine, based on concrete dialogue histories, whether harassment has occurred, and that can further generate individualized visual information, such as video or other visual content, that vividly illustrates the problematic aspects of the dialogue and suggests appropriate improvements. The invention addresses the problem of providing an automated and personalized harassment analysis and education mechanism that leverages generative AI models to generate visual information based on detected harassment in dialogue histories.

### SUMMARY

To solve the above problem, according to one aspect of the present invention, there is provided a system comprising a processor, wherein the processor is configured to receive a dialogue history as an input and determine whether the dialogue history constitutes harassment. The processor is further configured to generate a prompt to instruct generation of visual information based on the determination, and to cause visual information to be automatically generated by a generative AI model based on the prompt. In an embodiment, the processor is configured to analyze the dialogue history by using natural language processing techniques, such as tokenization, syntactic or semantic analysis, or classification, and to input an analysis result to the generative AI model so that the generated visual information reflects specific linguistic and contextual characteristics of the dialogue history. In another embodiment, the processor is configured to detect specific keywords or phrases in the dialogue history to determine abuse of power in a workplace or sexual harassment, and to perform the determination based on the detected keywords or phrases, such that the type and content of the visual information generated by the generative AI model can be adapted to a particular category of harassment. By combining automated harassment determination with prompt generation for a generative AI model, the system enables generation of individualized visual information that assists users in recognizing and correcting harassment-related behaviors.
The term “system” refers to an arrangement of one or more hardware and/or software components that cooperate to perform the processing described in the present specification and claims, including at least a processor and, optionally, memory, storage, communication interfaces, and external services.
The term “processor” refers to any hardware component, or combination of hardware components, that is capable of executing instructions, including but not limited to a central processing unit (CPU), a graphics processing unit (GPU), a digital signal processor (DSP), a microcontroller, a field-programmable gate array (FPGA), an application-specific integrated circuit (ASIC), or a combination thereof.
The term “dialogue history” refers to a collection of one or more utterances or messages exchanged between two or more parties, or issued by a single party over time, including but not limited to chat logs, email threads, meeting transcripts, voice-to-text transcripts, or other textual representations of communication.
The term “harassment” refers to inappropriate, offensive, or harmful communication or behavior contained in the dialogue history, including but not limited to abuse of power in a workplace, sexual harassment, or other forms of repeated or severe negative treatment that may cause psychological or emotional harm.
The term “determine whether the dialogue history constitutes harassment” refers to performing processing that classifies, judges, or otherwise evaluates the dialogue history so as to output a result indicating the presence or absence of harassment and, optionally, a type or degree of harassment.
The term “visual information” refers to any information that can be perceived visually by a human viewer, including but not limited to images, image sequences, videos, animations, graphical user interface elements, diagrams, or other visual representations.
The term “prompt” refers to data, including but not limited to text, tokens, parameter sets, or structured instructions, that is provided as input to a generative AI model in order to instruct or condition the generative AI model to generate particular visual information corresponding to a desired content or style.
The term “generative AI model” refers to a machine-learned model that is configured to generate new data, such as images, video frames, or other visual content, in response to a prompt, including but not limited to diffusion models, generative adversarial networks (GANs), transformer-based models, variational autoencoders (VAEs), or combinations thereof.
The term “automatically generated” refers to being generated by the system without requiring manual creation of the corresponding visual information by a human for each individual dialogue history, although human intervention may be involved in designing, training, or configuring the system in advance.
The term “natural language processing techniques” refers to computational methods for analyzing or processing human language text, including but not limited to tokenization, morphological analysis, syntactic parsing, semantic analysis, sentiment analysis, classification, entity recognition, or embedding generation.
The term “analysis result” refers to data obtained by applying natural language processing techniques to the dialogue history, including but not limited to feature vectors, classification labels, scores, extracted keywords or phrases, and intermediate representations that are used as input to the generative AI model.
The term “abuse of power in a workplace” refers to harassment in which a person in a relatively higher position, authority, or influence within a workplace environment engages in communication or behavior that unfairly demeans, threatens, coerces, or otherwise harms a person in a relatively lower position.
The term “sexual harassment” refers to harassment that includes sexual expressions, sexually suggestive comments, requests for sexual favors, or other communication or behavior of a sexual nature that may make a recipient or observer feel uncomfortable, threatened, or discriminated against.
The term “keywords or phrases” refers to specific lexical units, such as words, terms, or multi-word expressions, that are present in the dialogue history and that are associated, by rules or learned models, with harassment-related patterns including abuse of power or sexual harassment.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

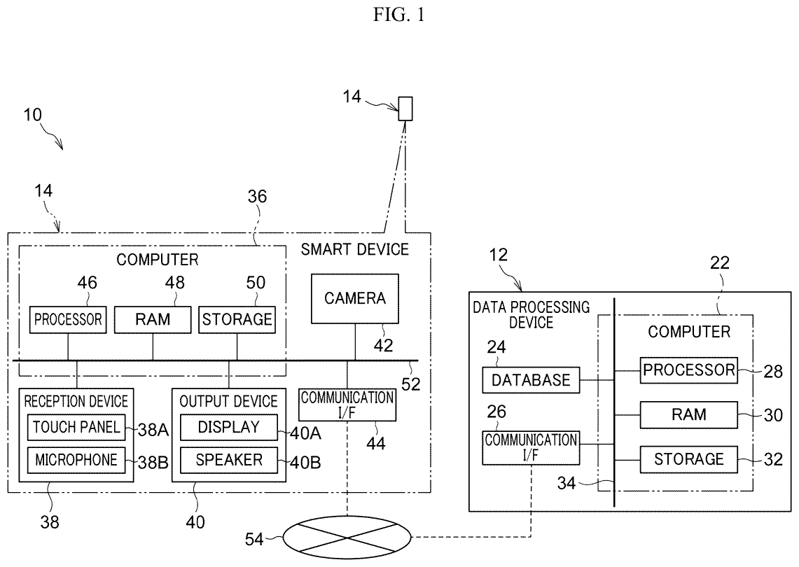

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

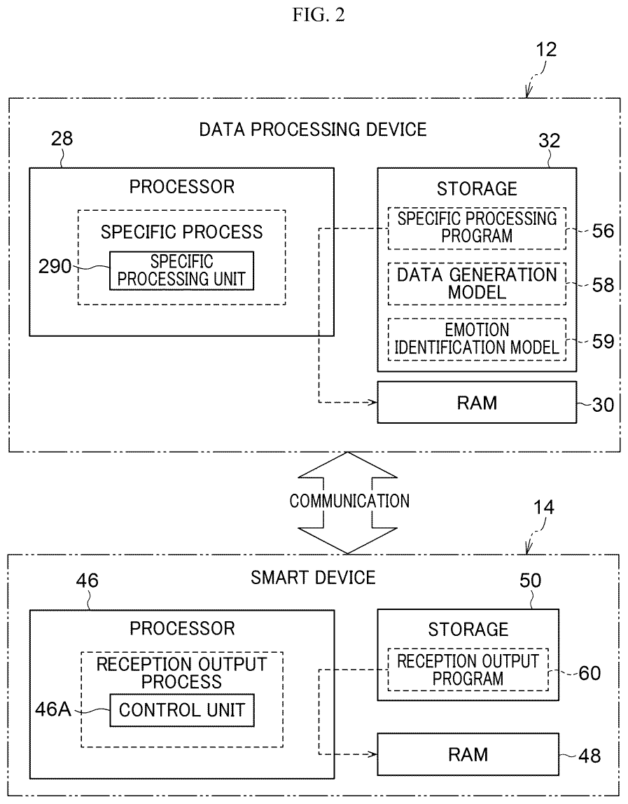

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented harassment detection systems primarily rely on simple keyword matching or shallow statistical heuristics applied to dialogue history data. Such systems suffer from several technical limitations in terms of information processing. First, these systems do not robustly capture long-range dependencies, syntactic relations, or contextual nuances in human language, which leads to low detection accuracy, especially in cases where inappropriate behavior is expressed indirectly or across multiple utterances. Second, conventional architectures typically separate rule-based detection from any downstream content generation, so intermediate analysis results are not efficiently reused to guide a downstream model, resulting in redundant computation and increased latency on server hardware. Third, known systems usually provide only binary or categorical outputs and do not generate machine-readable structured evaluation data that can drive automatic generation of visual information. As a result, there is no integrated pipeline that transforms raw dialogue history data into model-ready feature vectors, produces probabilistic evaluations of inappropriate behavior, and uses the same evaluation results to generate visual information indicative of the content and position of problematic portions in the dialogue. This leads to inefficient utilization of computing resources, fragmented data flows between natural language processing modules and generative models, and degraded usability from the standpoint of a computer system.

Moreover, existing server-side implementations often treat a user instruction as a simple label or option instead of a full prompt sentence that conditions a generative artificial intelligence model. Consequently, the server cannot systematically adapt its internal processing, feature extraction, and inference behavior to different user instructions without reconfiguring the underlying software modules or deploying multiple separate models. In addition, conventional systems are not configured to use feature-level outputs of natural language processing software (such as word frequency, context information, and dependency information) as structured inputs to a generative artificial intelligence model for both evaluation and content generation. This lack of integrated feature utilization prevents the system from achieving improved accuracy and robustness in model inference using the same hardware resources.

Therefore, there is a need for a computer-implemented system and server that technically improve harassment-related dialogue analysis by: (i) integrating natural language processing software and a generative artificial intelligence model in a unified processing pipeline, (ii) converting enriched language feature data and user-provided prompt sentences into numerical vector data optimized for deep learning frameworks, (iii) generating structured evaluation result data that includes probabilistic classification and confidence information, and (iv) using that evaluation result data to automatically generate visual information indicating both the content and position of inappropriate behavior. Such a system should improve the efficiency and accuracy of the server's information processing and provide a more effective machine-level representation for downstream tasks, thereby constituting a concrete improvement in computer technology rather than a mere automation of human judgment.

The specific processing by the specific processing unit 290 of the data processing device 12 in Example 1 is realized by the following means.

The present invention provides a server comprising a processor configured to receive dialogue history data from a communication terminal; execute instructions, by using natural language processing software, to segment the dialogue history data into morpheme-level and sentence-level units and to generate language feature data including part-of-speech information, syntactic information, word frequency information, context information, and dependency information; execute instructions to convert the language feature data and a prompt sentence including a user instruction into numerical vector data that is inputtable to a generative artificial intelligence model operating on a deep learning framework; execute instructions, by using the generative artificial intelligence model, to generate evaluation result data indicating presence or absence and a type of inappropriate behavior contained in the dialogue history data, together with confidence information, based on the prompt sentence and the dialogue history data; execute instructions, based on the evaluation result data, to specify at least one portion of the dialogue history data that relates to the inappropriate behavior and to generate a prompt sentence for expressing a specification result and the evaluation result data as visual information; execute instructions to input the generated prompt sentence into the generative artificial intelligence model or an image generation artificial intelligence model and to automatically generate visual information indicating content and position of the inappropriate behavior; and execute instructions to transmit the evaluation result data and the visual information to the communication terminal. This enables an integrated, computer-implemented processing pipeline in which a server improves the technical performance of harassment-related dialogue analysis by transforming raw text into enriched feature vectors, performing probabilistic evaluation through a generative artificial intelligence model under control of a prompt sentence, and reusing the structured evaluation results to drive automatic generation of visual information, thereby enhancing accuracy, efficiency, and utility of the server's information processing beyond conventional keyword-based or rule-based systems.
The term “dialogue history data” refers to electronic text data representing one or more segments of communication between persons, including, for example, messages, utterances, or transcripts, that are stored or processed by a computing system.
The term “communication terminal” refers to an electronic apparatus, such as a client device, user device, workstation, or mobile device, that transmits data to or receives data from a server via a communication network.
The term “inappropriate behavior” refers to a pattern or instance of behavior represented in dialogue history data that is determined, by a computing process, to be improper or undesirable in a human relationship, including, for example, behavior associated with abuse of authority or behavior associated with physical or private attributes.
The term “processor” refers to one or more hardware processing units, such as a central processing unit or graphics processing unit, configured to execute machine-readable instructions.
The term “natural language processing software” refers to a software component or software library that is configured to analyze human language text and to output structured information, such as tokenization results, part-of-speech tags, syntactic structures, or semantic features.
The term “morpheme-level unit” refers to a minimum meaningful segment of text, such as a word, subword, or other linguistically defined element, obtained by segmenting a character sequence during natural language processing.
The term “sentence-level unit” refers to a sequence of morpheme-level units that is identified as a sentence or clause boundary by a natural language processing process.
The term “language feature data” refers to structured data representing linguistic characteristics of dialogue history data, including, for example, part-of-speech information, syntactic information, word frequency information, context information, and dependency information.
The term “part-of-speech information” refers to data indicating grammatical categories assigned to tokens in text, such as noun, verb, adjective, adverb, or pronoun, as determined by a natural language processing process.
The term “syntactic information” refers to data indicating grammatical structure of text, including, for example, phrase boundaries, parse trees, or relations between clauses, as determined by a natural language processing process.
The term “word frequency information” refers to data indicating counts, frequencies, or distributions of occurrences of words or tokens within dialogue history data.
The term “context information” refers to data indicating surrounding linguistic or situational information associated with a token, a phrase, or a sentence, including, for example, neighboring tokens, sentence position, or co-occurrence patterns.
The term “dependency information” refers to data indicating dependency relations between tokens, such as head-dependent links in a dependency parse, that represent grammatical or semantic connections among words in text.
The term “prompt sentence” refers to a text sequence, including an instruction or request provided by a user or system, that conditions or controls behavior of a generative artificial intelligence model.
The term “numerical vector data” refers to one or more arrays of numerical values, such as real-valued vectors, matrices, or tensors, that represent text or features in a form suitable for input to a machine learning model.
The term “generative artificial intelligence model” refers to a trained computational model, such as a neural network, configured to generate outputs including classifications, predictions, or new content based on input data and learned parameters.
The term “deep learning framework” refers to a software platform or library configured to define, train, and execute neural networks using numerical computation, including operations on tensors.
The term “evaluation result data” refers to structured data produced by a model or processor that indicates a determination or assessment regarding dialogue history data, such as presence or absence of inappropriate behavior, a type of such behavior, and optionally associated numerical scores or confidence values.
The term “confidence information” refers to numerical data indicating a degree of certainty or probability associated with an output of a model, such as a classification result regarding inappropriate behavior.
The term “specify a portion” refers to an operation of identifying, within dialogue history data, one or more segments, such as tokens, phrases, sentences, or message units, that satisfy a condition related to inappropriate behavior.
The term “visual information” refers to data defining a visual representation, such as an image, graphical overlay, highlighting pattern, or layout, that is configured to visually express content and position of inappropriate behavior in dialogue history data.
The term “image generation artificial intelligence model” refers to a trained computational model configured to generate image data or other visual data in response to input data such as a prompt sentence or feature representation.
The term “probabilistically classify” refers to an operation in which a model assigns one or more categories to input data together with probability values or scores representing likelihoods of the categories.
The term “imbalance of authority in human relationships” refers to a relationship context in which one party is determined, based on model analysis, to hold a higher level of power or control over another party, and in which behavior associated with that context may constitute inappropriate behavior.
The term “physical characteristics or private domains” refers to attributes relating to an individual's body, appearance, personal life, or personal privacy that, when referenced in dialogue history data, may be associated with inappropriate behavior.
The term “transmit” refers to sending data from one computing element to another through a communication interface or network, such as a wired or wireless network connection.

In one embodiment, a server executes a harassment analysis system on general-purpose server hardware. The server includes at least one central processing unit and, optionally, one or more graphics processing units. The server runs an operating system such as a server-class operating system, and an application stack including a web framework, a numerical computation library, and a deep learning framework such as a generic deep learning library or an equivalent platform. The server stores program instructions and trained model parameters in a non-transitory computer-readable storage medium, such as a magnetic disk drive or solid-state drive.

The terminal operates as a client device and includes a processor, a display, an input unit, and a network interface. The terminal may be realized by a desktop computer, a notebook computer, a tablet, or a smartphone. The terminal executes a web browser or a native application that provides a graphical user interface for inputting and displaying dialogue history data and analysis results.

The user uses the terminal to input dialogue history data in free-text form into an input field displayed on the terminal. The user also optionally inputs a prompt sentence that describes how the generative AI model should analyze the dialogue history data. The user may type the following example prompt sentence into an instruction input field:
“Please determine whether this dialogue history contains any elements of harassment and explain your reasoning.”

Alternatively, the user may input:
“Classify whether this dialogue contains power harassment or sexual harassment, and explain your reasoning in two sentences.”

The terminal transmits the dialogue history data and the prompt sentence to the server via a communication network such as the internet. The server receives the data through a web application interface and stores the received dialogue history data and prompt sentence in a memory structure, for example as string fields in a request object and as entries within a temporary in-memory data store.

The server uses natural language processing software, such as a generic tokenization and parsing library or an equivalent natural language processing toolkit, to convert the dialogue history data from a raw character string into structured language feature data. The server applies a sequence of deterministic and statistical algorithms to perform tokenization, sentence splitting, part-of-speech tagging, and syntactic dependency parsing. The server generates, for each token, a record including at least:
a token identifier,
the original text span,
a part-of-speech tag,
a lemma,
a dependency relation label,
an index of a head token in a dependency tree.

The server aggregates these records into a graph-structured data object that represents each sentence as a dependency tree. The server also computes word frequency information by counting token occurrences over the dialogue history data and normalizing counts to obtain term frequency values. The server extracts local context information, such as the preceding and following tokens within a fixed-size window, and sentence-level context, such as the position of each sentence within the entire dialogue. The server encodes dependency information by recording adjacency lists or matrices describing syntactic edges between tokens.

The server converts language feature data into numerical vector data suitable for input to a generative AI model. The server uses a tokenizer associated with a neural network language model architecture, such as a generic transformer-based encoder-decoder or decoder-only model. The server maps each token in the dialogue history data and the prompt sentence to an integer index using a shared vocabulary. The server then constructs a sequence of token indices and corresponding attention masks. The server embeds each token index into a continuous vector space using an embedding layer defined by pre-trained or fine-tuned weight matrices. The server augments these token embeddings with additional feature vectors derived from the language feature data, such as:
a one-hot or low-dimensional encoding of the part-of-speech tag,
a positional encoding based on sentence index and token index within the sentence,
an encoding of dependency roles (for example, subject, object, modifier),
a scalar or vector representing normalized word frequency,
context indicators for dialogue structure, such as speaker turns if available.

The server concatenates or linearly combines these feature vectors to produce a final representation vector for each token. This non-conventional integration of linguistic features and model-specific token embeddings causes the subsequent neural network layers to receive richer and more discriminative input, thereby improving detection accuracy and reducing the amount of training data needed for a given performance level.

The server structures the combined prompt sentence and dialogue history data so that the generative AI model can interpret them as instruction-plus-context. In one embodiment, the server inserts special control tokens to delimit sections, for example a control token before the prompt sentence and another control token before the dialogue text. The server constructs an input sequence such that the model can condition its hidden states first on the prompt sentence and then on the dialogue history data. This design allows the same generative AI model to alter its behavior dynamically according to different prompt sentences, without reconfiguring or swapping models, which improves computational efficiency and flexibility on the server.

The server employs a generative AI model realized as a multi-layer transformer neural network. The server defines the model with the following components:
an embedding layer that converts token indices to dense vectors,
a plurality of self-attention layers that compute attention scores between tokens using scaled dot-product attention,
feed-forward sublayers that apply non-linear transformations to intermediate representations,
layer normalization and residual connections to stabilize training and inference,
an output head configured both for sequence classification and text generation.

The server configures the classification head to map the final hidden state representations to logits corresponding to multiple classes, such as “no inappropriate behavior,” “inappropriate behavior related to imbalance of authority,” and “inappropriate behavior related to physical characteristics or private domains.” The server applies a softmax function to obtain class probabilities. The server computes confidence information as probability values or as calibrated scores derived from the logits.

The server trains the generative AI model on a large training dataset composed of labeled dialogue history data paired with annotations indicating presence or absence and type of inappropriate behavior. During training, the server uses a multi-task learning strategy. The server defines a cross-entropy loss for the classification task and, when training the generative explanation head, defines another cross-entropy loss for sequence generation of explanatory text. The server combines these losses with a weighting parameter to optimize both classification and explanation generation simultaneously. The server updates the model parameters by applying a gradient-based optimization algorithm such as stochastic gradient descent with momentum or an adaptive learning rate method. The server backpropagates gradients through attention layers, feed-forward layers, and embedding layers, and updates parameters stored in a weight matrix on the server's memory. The server optionally applies data augmentation, such as paraphrasing or noise injection at the token level, to improve model robustness and reduce overfitting.

The server designs decision thresholds for inappropriate behavior classification based on validation data statistics. The server selects threshold values that trade off between false positives and false negatives in a manner consistent with predetermined performance criteria.

The server stores these thresholds and uses them at inference time to convert probability outputs into binary or multi-class determinations contained in evaluation result data.

The server generates evaluation result data as a structured object, including at least:
a class label indicating presence or absence and type of inappropriate behavior,
a numerical confidence score for each class,
a list of token indices or sentence indices that contribute most strongly to the decision, derived from attention weights or gradient-based importance measures,
optional generated explanation text that summarizes the reasoning in natural language.

The server uses the evaluation result data to specify portions of the dialogue history data related to inappropriate behavior. The server identifies tokens or sentences whose importance scores exceed a threshold. The server maps these indices back to character spans in the original text and produces a list of segments to be highlighted or otherwise visually emphasized. The server then constructs a prompt sentence targeted for visual information generation. For example, the server constructs a prompt sentence such as:
“Generate an image that visually indicates the parts of the following dialogue that involve abuse of authority, highlighting those parts distinctly.”
   or
“Generate a visual representation that marks the sentences corresponding to inappropriate comments about physical appearance.”

The server inputs the visual-generation prompt sentence, optionally combined with a symbolic representation of the highlighted segments, into either the same generative AI model configured for multimodal generation, or into a separate image generation model. This model may follow a diffusion-based or auto-regressive image generation architecture that accepts text embeddings and outputs image data. The server encodes the prompt sentence, generates image feature maps layer by layer, and ultimately produces pixel data or vector graphics describing visual information, such as a schematic dialogue box with highlighted lines, an annotated chart, or another structured visualization of the inappropriate segments and types.

The server transmits both the evaluation result data and the visual information to the terminal over the network. The terminal receives this data and renders a user interface in which the original dialogue history is displayed with problematic segments highlighted. The terminal also displays the classification label and confidence value, and may show the generated explanation text adjacent to the dialogue or overlaid in a separate detail panel. In one embodiment, the terminal additionally displays the generated image on the display, such as a diagram that visually indicates the sequence and intensity of inappropriate utterances. This user interface presentation is facilitated by the structured representation of indices and positions produced by the server.

The described integration of natural language processing software, feature-level augmentation, and a generative AI model results in concrete improvements to computer technology. The server reduces communication load by transmitting structured evaluation result data and compact visual information, rather than raw feature data or intermediate internal states. The server improves processing speed by reusing a single generative AI model whose behavior is controlled via prompt sentences, instead of executing multiple specialized models. The server improves accuracy and error robustness by enriching token embeddings with part-of-speech tags, dependency information, and context signals, which enhances the model's ability to capture long-range dependencies and subtle expressions that are difficult to handle with rule-based or keyword-based methods.

The server behaves differently from conventional systems that merely automate human review, because the server uses non-intuitive, high-dimensional vector transformations and multi-head attention mechanisms that identify interaction patterns in dialogue history data that are not explicitly defined by human-designed rules. The server applies a feature-weighting mechanism that propagates importance scores back from output layers to individual tokens, enabling the server to identify text portions contributing most to classification decisions according to internal model metrics. This mechanism is not a simple human rule set but rather arises from the model's learned parameters and gradient-based optimization processes.

The server architecture described above is modular and admits alternative embodiments. In one variation, the server employs a recurrent neural network or convolutional neural network instead of a transformer, while still using feature-level integration of natural language processing outputs. In another variation, the server uses a separate encoder network for the dialogue history data and a separate encoder network for the prompt sentence, and then fuses their encoded representations using a cross-attention mechanism before classification and generation. In yet another embodiment, the server quantizes model weights and activations to reduced-precision formats in order to improve computational efficiency and reduce memory footprint, which yields faster inference on hardware accelerators.

The terminal may also vary. In one embodiment, the terminal downloads the visual information as image data and uses hardware acceleration on the terminal's graphics processing unit to render complex overlays and animations, thus providing real-time feedback to the user even when network latency is present. In another embodiment, the terminal caches previous evaluation results and visualizations to reduce repeated transmission of identical or similar data, thereby reducing communication bandwidth usage.

The user can adjust the behavior of the system by providing different prompt sentences without reprogramming the server. For example, the user may enter:
“Highlight only the sentences that are borderline inappropriate and explain why they are risky but not clearly abusive.”
   or
“Summarize the most problematic three utterances in this dialogue.”

The server interprets these prompt sentences as control signals that modify how the generative AI model generates explanations and how the evaluation result data is structured and filtered. Because the model is trained to condition its outputs on such prompt sentences, the server leverages the same underlying architecture to support new analysis modes, thereby extending functionality while keeping model deployment overhead low.

As a result, the system as implemented by the server, the terminal, and the user interaction constitutes not only an automation of content judgment, but also a specific improvement to the way computers represent, process, and visualize complex dialogue text. The integrated data structures, feature engineering, model architecture, and use of prompt sentences combine to enhance computational efficiency, precision of detection, interpretability of results, and network utilization, thereby providing a technical solution to the technical problems identified.

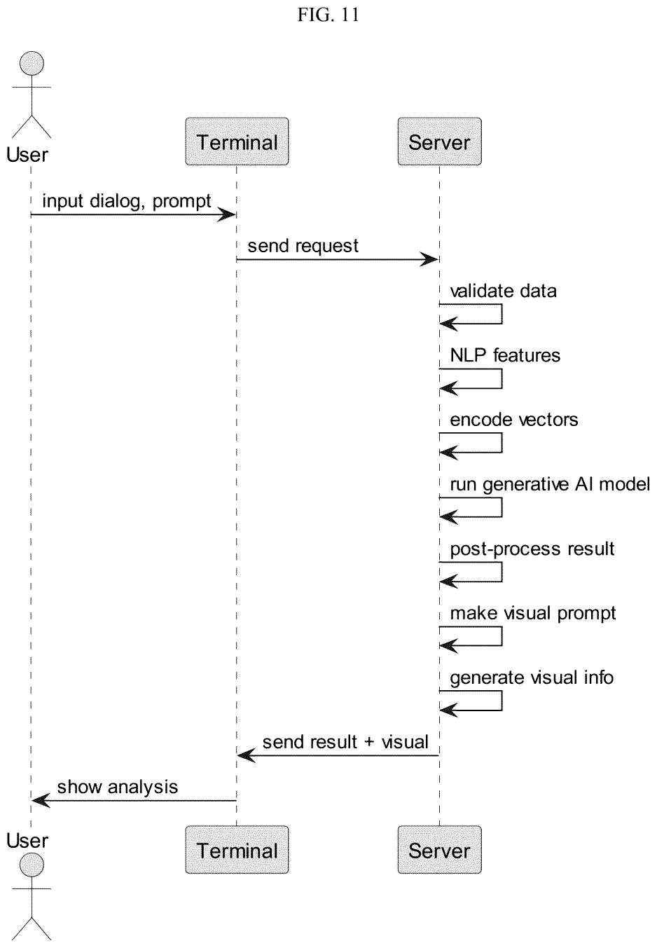

The following describes the processing flow using FIG. 11.

### Step 1:

The user operates the terminal to input dialogue history data and a prompt sentence. The user enters one or more utterances into a text input field, and optionally enters an instruction as a prompt sentence, such as “Please determine whether this dialogue history contains any elements of harassment and explain your reasoning.” The input of this step consists of human-readable text typed or pasted by the user. The output of this step consists of raw dialogue text and a raw prompt sentence stored in memory of the terminal as character strings.

### Step 2:

The terminal prepares a request message including the dialogue history data and the prompt sentence and sends the request to the server. The terminal converts the internal character strings into a structured data object, assigns field names such as “dialogue_history” and “prompt_sentence,” and encodes the object according to a communication protocol. The input of this step consists of the raw strings stored on the terminal. The terminal performs data packaging and network transmission operations, and the output of this step consists of a formatted request transmitted over a communication network and received at a network interface of the server.

### Step 3:

The server receives the request and validates the dialogue history data and the prompt sentence. The server parses the received data object, extracts the dialogue history field and the prompt sentence field, and checks properties such as non-emptiness, maximum length, and character encoding. The input of this step consists of the formatted request received from the terminal. The server executes parsing and validation operations, and the output of this step consists of validated dialogue history text and a validated prompt sentence stored in server memory as internal text variables.

### Step 4:

The server applies natural language processing software to the dialogue history text to generate language feature data. The server uses a tokenization and parsing library to segment the text into sentences and tokens, assign part-of-speech tags, and compute syntactic dependencies. The input of this step consists of the validated dialogue history text. The server performs tokenization, tagging, parsing, and counting operations to derive word frequency, context windows, and dependency relations. The output of this step consists of structured language feature data, including token lists, sentence boundaries, part-of-speech tags, dependency trees, and frequency counts, stored as data structures in memory.

### Step 5:

The server encodes the dialogue history text, the prompt sentence, and the language feature data into numerical vector data suitable for a generative AI model. The server uses a tokenizer associated with a transformer-based model to map tokens to integer indices and constructs attention masks and segment identifiers. The input of this step consists of the dialogue history text, the prompt sentence, and the language feature data. The server combines token indices with feature embeddings, such as part-of-speech vectors, dependency role encodings, positional encodings, and normalized frequency values, and performs linear algebra operations to form composite vectors. The output of this step consists of numerical tensors representing the prompt sentence and the dialogue history, together with feature-enriched token embeddings, stored in a format directly consumable by the generative AI model.

### Step 6:

The server executes inference using the generative AI model on the numerical vector data to obtain evaluation result data. The server loads a transformer neural network with pre-trained weights, feeds the tensors into the model, and computes forward passes through multiple attention layers and feed-forward layers. The input of this step consists of the feature-enriched tensors from Step 5. The server performs matrix multiplications, non-linear activations, attention weight calculations, and output-layer projections to compute class logits and, if configured, explanatory text tokens. The output of this step consists of raw model outputs, including class logits for inappropriate behavior types, probability values derived from softmax operations, and optional generated token sequences for explanations, all stored in memory.

### Step 7:

The server post-processes the raw model outputs to create structured evaluation result data. The server compares class probabilities with predetermined thresholds to decide whether inappropriate behavior is present and, if present, which type is most probable. The server interprets attention weights or gradient-based importance scores to identify tokens and sentences that contribute strongly to the decision. The input of this step consists of the logits, probabilities, and internal importance scores computed by the generative AI model. The server performs thresholding, maximum selection, and index-mapping operations to produce a classification label, confidence values, a list of indices corresponding to problematic text segments, and optionally a natural language explanation decoded from generated tokens. The output of this step consists of evaluation result data structured as a machine-readable object in server memory.

### Step 8:

The server specifies portions of the dialogue history data related to inappropriate behavior and constructs a new prompt sentence for visual information generation. The server maps the indices of important tokens or sentences back to the original character positions in the dialogue history text and groups contiguous segments into highlight regions. The input of this step consists of the evaluation result data and the original dialogue history text. The server executes index translation, region grouping, and text extraction operations to define segments representing inappropriate behavior, and then constructs a prompt sentence describing what kind of visual representation should be generated, such as “Generate a visual representation that highlights the following dialogue segments that involve abuse of authority.” The output of this step consists of a list of highlighted text segments and a visual-generation prompt sentence stored as text in server memory.

### Step 9:

The server inputs the visual-generation prompt sentence, and optionally symbolic representations of the highlighted segments, into a generative AI model or an image generation model to produce visual information. The input of this step consists of the newly constructed prompt sentence and segment descriptors. The server encodes this input into numerical vectors using a text encoder, then performs forward propagation through an image generation network or a multimodal generative network, executing convolution, attention, or diffusion operations to synthesize image data or overlay instructions. The output of this step consists of visual information, such as pixel data for an image or structured drawing instructions that represent the content and position of inappropriate behavior in the dialogue.

### Step 10:

The server prepares a response message containing the evaluation result data and the visual information and transmits the response to the terminal. The input of this step consists of the structured evaluation result object and the generated visual information in server memory. The server serializes these data items into a response format, attaches appropriate status codes and metadata, and sends the response over the communication network. The output of this step consists of a network response message that reaches the terminal.

### Step 11:

The terminal receives the response message from the server and renders the analysis results and visual information to the user. The input of this step consists of the received evaluation result data and visual information. The terminal parses the response, extracts the classification label, confidence values, explanation text, and visual representation, and performs display operations such as drawing text, highlighting dialogue segments, and rendering images on the display unit. The output of this step consists of a user-visible interface in which the dialogue history data is shown together with indications of inappropriate behavior, classification results, and any generated visual elements that help the user understand the analysis.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented systems for monitoring workplace communications and detecting harassment mainly rely on simple keyword lists, static rule sets, or post-hoc manual review. Such approaches suffer from several technical limitations.

First, conventional systems often process conversation logs as coarse-grained text blocks without fine-grained analysis of utterance units, sentiment, or contextual cues. As a result, the systems either fail to detect nuanced or indirect harassment or generate excessive false positives, which degrades the reliability of automated detection and requires substantial manual intervention. This leads to inefficient utilization of computing resources and diminishes the practical utility of automated monitoring.

Second, existing systems typically perform harassment detection and alerting as isolated functions, without integrating downstream content generation or structured guidance. When a potential harassment event is detected, the system generally stores a flag or sends a minimal notification, leaving human operators to manually interpret the raw text and determine appropriate responses. This fragmented workflow increases processing latency, requires repeated access to the same data, and prevents effective reuse of prior analysis results at the system level.

Third, many known approaches do not provide a unified mechanism for coupling speech recognition, natural language processing, harassment scoring, prompt construction, and generative model invocation within a single coordinated processing pipeline. Audio acquisition, transcription, analysis, and alert generation are often implemented as loosely connected components, which results in fragmented data flows, redundant computation, and lack of consistent data association across modules. This fragmentation makes it difficult to maintain traceability between the original conversation, the analysis results, and the generated guidance or visual information.

Fourth, conventional systems do not systematically leverage generative models in a structured and controllable way for post-detection processing. Even where generative models are introduced, prompts are often ad hoc and not derived from machine-computed risk scores, ranking of utterance units, or formalized instruction patterns. This limits the quality, consistency, and reproducibility of automatically generated summaries, explanations, recommended response policies, and educational content, and fails to fully utilize the underlying computational capabilities.

Fifth, known harassment monitoring solutions frequently lack an integrated storage and retrieval architecture that records, in association with one another, the analysis target information, evaluation values, risk levels, generated prompts, and generated visual information. Without such association, it is technically difficult for the server to support reliable post hoc auditing, aggregated analysis over time, and systematic generation of training or educational materials based on accumulated incidents.

Accordingly, there is a need for an improved computer-implemented system and server architecture that: (i) converts audio-based conversation histories into structured analysis target information; (ii) performs multi-stage natural language processing and computation of harassment-related evaluation values and risk levels; (iii) automatically constructs structured prompt sentences conditioned on high-risk utterance units and computed scores; (iv) invokes a generative information processing model to produce contextually tailored visual information such as summaries, explanations, response policies, and educational content; and (v) generates and transmits notification information with consistent identifiers and metadata, while recording all relevant data in an associated manner for later viewing and aggregation. Such a system would improve the technical functioning of computer-based harassment monitoring by enabling more accurate, context-aware detection, more efficient use of processing results across components, and more effective automated support for human decision-makers.

The specific processing by the specific processing unit 290 of the data processing device 12 in Application Example 1 is realized by the following means.

The present invention provides a server comprising a processor and a memory storing instructions that, when executed by the processor, cause the processor to acquire audio information including a conversation history from a terminal and convert the audio information into character information by performing speech recognition processing, to store the character information as analysis target information in the memory, to analyze the analysis target information by executing natural language processing including emotion analysis, classification analysis, and keyword extraction, to calculate an evaluation value and a risk level indicating a possibility of harassment, to determine whether the conversation history corresponds to harassment on the basis of the evaluation value and the risk level, to extract, from a conversation history determined as harassment, an utterance unit having a high possibility of harassment, to generate a structured prompt sentence including the utterance unit, the evaluation value, and the risk level, to input the prompt sentence into a generative information processing model so as to cause the generative information processing model to automatically generate visual information including at least one of summary information, explanatory information, response policy information, and educational information relating to the conversation history, to generate notification information including at least a part of the visual information and text information corresponding to the utterance unit and transmit the notification information to a management terminal when the risk level is equal to or greater than a predetermined threshold, and to record, in association with one another in the memory, the analysis target information, the evaluation value, the risk level, the prompt sentence, and the visual information generated by the generative information processing model for later viewing and aggregation processing. This enables an integrated and technically improved harassment monitoring workflow in which audio-based conversation data is automatically transcribed, analyzed, scored, and transformed into structured prompts that drive a generative model to produce actionable visual information, while maintaining consistent association between original data, analysis results, generated content, and notifications, thereby enhancing detection accuracy, reducing redundant processing, and providing more effective computer-assisted support for administrators.
The term “audio information” refers to electronic data representing sound, including but not limited to recorded speech signals obtained from a microphone of a terminal or other input apparatus, in analog or digital form suitable for processing by a computing device.
The term “conversation history” refers to a sequence of utterances exchanged between one or more persons, represented as audio information, character information, or a combination thereof, and optionally including metadata such as timestamps, speaker identifiers, and session identifiers.
The term “character information” refers to text data obtained by converting audio information into a symbolic representation, such as alphanumeric characters or other script, which can be processed by natural language processing functions.
The term “speech recognition processing” refers to a computational procedure that analyzes audio information representing speech and outputs corresponding character information, using one or more acoustic models, language models, or pattern recognition algorithms executed by a computing device.
The term “analysis target information” refers to character information derived from a conversation history, or a portion thereof, that is stored in a memory and subjected to one or more analysis procedures including natural language processing.
The term “natural language processing” refers to a class of computational techniques that operate on character information representing human language in order to derive structured information, including but not limited to emotion analysis, classification analysis, keyword extraction, syntactic analysis, and semantic analysis.
The term “emotion analysis” refers to a type of natural language processing that evaluates character information to estimate an emotional state or polarity, such as positive, negative, or neutral sentiment, and may output one or more numerical scores or labels.
The term “classification analysis” refers to a type of natural language processing that assigns one or more categories, labels, or classes to character information, such as categories indicating harassment, abuse, or other content types, based on statistical or rule-based models.
The term “keyword extraction” refers to a type of natural language processing that identifies words, phrases, or tokens in character information that are deemed important or indicative of particular concepts, such as harassment-related expressions.
The term “evaluation value” refers to a numerical or categorical metric calculated on the basis of analysis target information, which indicates a degree or likelihood that a conversation history or an utterance contains harassment or related problematic content.
The term “risk level” refers to a discrete or continuous indicator derived from the evaluation value and other analysis results, representing a relative severity or priority of a potential harassment event, and used for threshold-based decision making.
The term “harassment” refers to abusive, threatening, discriminatory, or otherwise inappropriate behavior expressed in a conversation history, including but not limited to power harassment, sexual harassment, or other forms of verbal misconduct, as determined by the analysis and decision logic of the system.
The term “utterance unit” refers to a segment of a conversation history corresponding to a single spoken or written expression, such as a sentence, phrase, or turn of speech associated with a single speaker, used as a minimum analysis or extraction unit in the system.
The term “prompt sentence” refers to structured character information constructed by the system, including one or more utterance units, evaluation values, risk levels, and instruction sentences, and provided as input to a generative information processing model to control the content and format of generated output.
The term “instruction sentence” refers to a portion of a prompt sentence that specifies to a generative information processing model what type of output is requested, such as an explanation of a determination reason, response procedures, or examples of non-harassing expressions.
The term “generative information processing model” refers to a computational model, such as a generative artificial intelligence model, that receives a prompt sentence as input and generates new information, including text or visual information, based on learned statistical patterns or other generation mechanisms.
The term “visual information” refers to information formatted for presentation in a human-perceivable visual form, including but not limited to text summaries, graphical indicators, structured reports, diagrams, or user interface elements derived from analysis results or generated by a generative information processing model.
The term “summary information” refers to visual information that condenses a conversation history or incident into a shorter representation highlighting main points, such as key utterances, detected harassment, and overall context.
The term “explanatory information” refers to visual information that describes reasons, factors, or analytical bases for a determination, such as explanations of why certain utterances are classified as harassment.
The term “response policy information” refers to visual information that provides guidance, recommendations, or procedures for handling a detected harassment case, including suggested actions for a manager or administrator.
The term “educational information” refers to visual information intended for training or awareness purposes, such as example scenarios, explanations of inappropriate behavior, and alternative non-harassing expressions.
The term “notification information” refers to data generated by the system for the purpose of alerting a management terminal or other device to a detection event, including identifiers, text excerpts, risk levels, timestamps, and links or identifiers for accessing related visual information.
The term “management terminal” refers to an electronic device operated by a manager, administrator, or other authorized person, such as a personal computer, smartphone, or tablet, that receives notification information and displays visual information related to detected harassment incidents.
The term “communication control function” refers to a set of software or hardware functions executed by the server or another computing component to transmit and receive data, including notification information, over a communication network according to predefined protocols.
The term “memory” refers to a storage component of a computing device, including volatile memory, nonvolatile memory, or a combination thereof, that stores analysis target information, evaluation values, risk levels, prompt sentences, generated visual information, and related data.
The term “record in association with one another” refers to storing multiple items of data in the memory in such a way that logical relationships or identifiers allow retrieval of the items together, including storing them in related fields of a database record, linked records, or data structures with common keys.
The term “predetermined threshold” refers to a value or condition set in advance in the system, such as a numerical risk level or score, used as a criterion to trigger specific processing, including generation of notification information or invocation of a generative information processing model.
The term “server” refers to a computing apparatus or combination of computing resources that executes the processor and memory functions described in the invention, and that provides services such as analysis, generation, recording, and notification over a communication network.
The term “terminal” refers to a user-side computing device, such as a smartphone, tablet, wearable device, or personal computer, that acquires audio information of conversation history and communicates with the server.
The term “management terminal identification information” refers to information used to identify or address a management terminal in a communication network, including device identifiers, account identifiers, or communication tokens.
The term “occurrence time” refers to time-related metadata indicating when an utterance, conversation history, or detection event occurred, including timestamps recorded by the terminal or server.
The term “identification information of the conversation history” refers to data, such as a conversation ID or session ID, that uniquely or distinctively identifies a particular conversation history within the system.

In one embodiment, a server cooperates with one or more terminals operated by users and managers to implement the claimed system. The server includes at least one processor, a memory, a nonvolatile storage device, and a network interface. The terminal includes at least one processor, a memory, a microphone, a display, and a network interface. The user carries the terminal in a workplace environment and speaks during ordinary work activities. The terminal acquires audio information of these conversations, the server performs analysis and generation processing, and the terminal of a manager displays notifications and visual information.

The terminal uses an audio driver and an operating system audio API, such as a mobile operating system audio capture API, to sample analog sound signals from the microphone and convert the signals into digital audio information. The terminal represents the audio information as a stream of pulse-code-modulated samples or a compressed digital audio format such as a linear predictive coding format. The terminal segments the audio information into fixed-length frames and associates each frame with a timestamp and a session identifier. By structuring the audio information in this way, the terminal enables the server to later align utterance units with precise times and sessions, which is technically beneficial for accurate risk localization and subsequent auditing.

The terminal transmits the audio information to the server or to a speech recognition service over a communication network using a secure transport protocol. The server or the speech recognition service executes a speech recognition model, which can be a deep neural network implementing a hybrid acoustic-linguistic model or an end-to-end sequence-to-sequence model. In one implementation, the speech recognition model includes a stack of convolutional layers to extract acoustic features, followed by recurrent layers such as long short-term memory units, and a final softmax layer for phoneme or subword unit classification. The model is trained using an objective function such as connectionist temporal classification loss or cross-entropy loss, and the training includes weight updates by stochastic gradient descent or a variant of gradient-based optimization. The server or the speech recognition service converts the audio information into character information by applying the trained model to the acoustic features and decoding the output probabilities with a beam search algorithm constrained by a language model.

The server receives the character information and stores the character information as analysis target information in a memory in association with metadata such as conversation identifiers, speaker identifiers, and occurrence times. The server structures the analysis target information as a sequence of utterance records, each utterance record including fields for raw text, normalized text, token list, part-of-speech tags, dependency relations, and speaker labels. This specific data structure enables the server to perform natural language processing at the granularity of individual utterance units, and to reuse intermediate representations such as tokenization and syntactic parsing across multiple downstream analyses, which improves computational efficiency.

The server executes a natural language processing pipeline on the analysis target information.

The server uses a tokenizer to segment the character information into tokens and uses a morphological analyzer and a part-of-speech tagger to assign grammatical categories. The server applies a dependency parser, such as a graph-based or transition-based parser implemented by a neural network, to determine syntactic relations between tokens. The server extracts feature vectors for each utterance, including bag-of-words features, n-gram features, syntactic pattern features, and contextual embedding vectors generated by a pre-trained language model such as a transformer encoder. The server stores these feature vectors in association with the corresponding utterance records.

The server applies emotion analysis by using a sentiment classification model. In one embodiment, the server uses a neural network with an embedding layer, multiple self-attention layers, and a classification head that outputs a sentiment score or distribution over sentiment labels. The server computes an emotion score, such as a polarity value and an intensity value, for each utterance and for the conversation as a whole. The server also uses classification analysis to detect harassment categories by applying a multi-label classifier that takes the feature vectors as input and outputs probabilities for harassment-related classes. The server uses a loss function such as binary cross-entropy during training, and the server may use regularization techniques such as dropout and weight decay to avoid overfitting.

The server executes keyword extraction by determining, for each token or phrase, an importance score based on term frequency-inverse document frequency values, attention weights from the classification model, or positional and syntactic roles. The server identifies a set of harassment-indicative keywords and phrases, and associates these with the corresponding utterance records. Unlike simple keyword matching performed in conventional systems, the server uses the combination of learned attention distributions and syntactic roles to distinguish between benign and abusive uses of similar terms, thereby reducing false positives and increasing detection precision.

The server calculates an evaluation value for each utterance and for the conversation as a whole by combining multiple signals: sentiment scores, harassment class probabilities, keyword importance scores, and contextual features such as repetition of negative expressions within a time window. The server may implement this combination as a weighted linear function, a gradient boosting model, or a shallow neural network, whose parameters are determined by training on labeled conversation data. The server further converts the evaluation value into a discrete risk level by comparing the evaluation value to multiple thresholds stored in the memory. The server thereby determines whether the conversation history corresponds to harassment and assigns a risk level such as low, medium, or high.

The server selects an utterance unit having a high possibility of harassment by ranking utterance records according to their evaluation values and keyword densities. The server extracts one or more top-ranked utterance units and marks them as trigger segments. The server generates a prompt sentence that includes at least the trigger segments in textual form, their associated evaluation values and risk levels, and one or more instruction sentences. Each instruction sentence specifies a particular task for a generative information processing model, such as “explain why this utterance may be harassment,” “propose response procedures for a manager,” or “rewrite this utterance into a non-harassing expression.” By constructing the prompt sentence according to a fixed schema that incorporates machine-computed values and ranked utterances, the server achieves a consistent and reproducible interface to the generative AI model, which is technically advantageous compared to ad hoc prompt construction.

In one example, the server constructs the following prompt sentence:
“The following is an excerpt from a workplace conversation.
Text: ‘You are always useless; you never do anything right.’
1. Briefly explain why this statement may be considered workplace harassment.
2. Suggest three concrete steps a manager should take after receiving a report containing this statement.
3. Provide an example of how feedback could be expressed in a constructive, non-harassing way in a similar situation.”

The server then inputs the prompt sentence into a generative information processing model. In one embodiment, the generative information processing model is a transformer-based language model including an embedding layer, multiple self-attention blocks, feed-forward layers, and an output projection layer. The model has been trained on large amounts of text data using an autoregressive objective, where the model predicts the next token given preceding tokens. The model's parameters are optimized by minimizing prediction error through gradient descent and backpropagation through time. The server may further fine-tune the generative model on domain-specific harassment data so that the model produces outputs with suitable tone and content for workplace compliance contexts.

The server obtains generated output from the generative information processing model and interprets the output as visual information. The server structures the visual information as a data record that includes fields for summary information, explanatory information, response policy information, and educational information. The server stores this data record in the memory and associates it with the conversation identifier and the utterance records. The server can then render the visual information on a management terminal, for example as a graphical user interface screen showing the problematic utterances, the model-generated explanation of why the utterances are problematic, recommended steps for the manager, and example non-harassing rephrasings.

When the server determines that the risk level is equal to or greater than a predetermined threshold, the server generates notification information. The server composes notification data including identification information of the conversation history, an excerpt of the trigger segment, the risk level, the occurrence time, and an identifier for accessing the stored visual information. The server sends the notification information to a management terminal by using a communication control function implemented over a push notification service or a message queue. The management terminal receives the notification and presents an alert on its display, enabling a manager to quickly recognize high-risk events and access detailed visual information.

The server records, in the memory, the analysis target information, the evaluation values, the risk levels, the generated prompt sentences, and the generated visual information in association with one another. The server uses a database management system to maintain tables or collections in which conversation records, utterance records, analysis records, prompt records, and generated content records share common keys such as conversation identifiers. This data structure enables the server to retrieve complete incident histories efficiently, to perform aggregated statistical analysis such as counting high-risk events per department or per time period, and to generate new educational scenarios by sampling past incidents and constructing new prompt sentences for the generative model. The associated recording also provides a technological improvement in data traceability, because an administrator can later trace back from a notification to the exact original utterance, the computed evaluation values, the prompt used, and the generative model outputs.

The system provides technical effects beyond mere automation of human judgment. The server uses multi-stage machine learning models and structured data representations to filter and rank utterances before invoking the generative model, thereby reducing the size and complexity of the input to the generative model. This reduces computational load and latency on the server and improves throughput when processing large volumes of conversation data.

The use of learned feature representations and model-based combination of evaluation signals leads to improved detection accuracy compared with simple keyword lists, because the server can take into account nuanced contextual factors and patterns of repeated behavior. The structured prompt generation method improves the quality and consistency of generated visual information, which in turn reduces the need for manual reinterpretation of raw text.

The system further improves computer technology by optimizing memory usage and network bandwidth. The terminal performs audio segmentation and optional local buffering to avoid transmitting continuous raw audio streams, and the server stores analysis target information and derived representations in a normalized form that can be reused by multiple modules.

The server may also compress the analysis representations and generated visual information, and send only compact notification data to the management terminal, thereby reducing communication overhead. Because the server maintains a unified data model for all processing stages, duplication of intermediate data is reduced and cache re-use is facilitated, which enhances computational efficiency.

In an alternative embodiment, the terminal performs the speech recognition processing locally, using a locally stored acoustic-linguistic model optimized for the terminal's hardware. The terminal converts the audio information into character information and directly sends the analysis target information to the server. This variation reduces the bandwidth required for audio transmission at the expense of increased processing load on the terminal.

The server then performs the same natural language processing, evaluation, prompt generation, generative modeling, notification, and recording as described above.

In another embodiment, the server applies a rule-based post-filter in combination with the machine learning models. After computing the evaluation values and risk levels, the server applies a set of explicit rules that encode domain-specific patterns, such as repeated use of imperatives directed at subordinate speakers or combinations of derogatory adjectives with personal pronouns. The server modifies the evaluation values based on these rules, thereby implementing a non-conventional hybrid of statistical learning and expert-crafted rules. This hybrid design enables the server to capture both learned patterns and explicit non-negotiable conditions, improving robustness to changes in language use.

The system can also be extended to support additional languages and domains. The server may maintain multiple language-specific natural language processing pipelines, each with its own tokenizer, parser, and classification models. The server selects an appropriate pipeline based on language identification performed on the character information. The server may further maintain different sets of harassment-related categories and risk thresholds for different regulatory environments or organizational policies, while reusing the same underlying generative information processing model with different prompt templates.

In all embodiments, the server, the terminal, and the user cooperate so that the system not only monitors workplace communication but also improves the internal operation of computer-based analysis and generation. By defining specific data structures for utterance units, by implementing a multi-stage evaluation and ranking process, and by using structured prompt sentences that incorporate computed scores and explicit instructions, the system achieves technical improvements in detection performance, processing efficiency, and data management compared with conventional systems that simply store text and apply naive keyword rules or unstructured generative prompts.

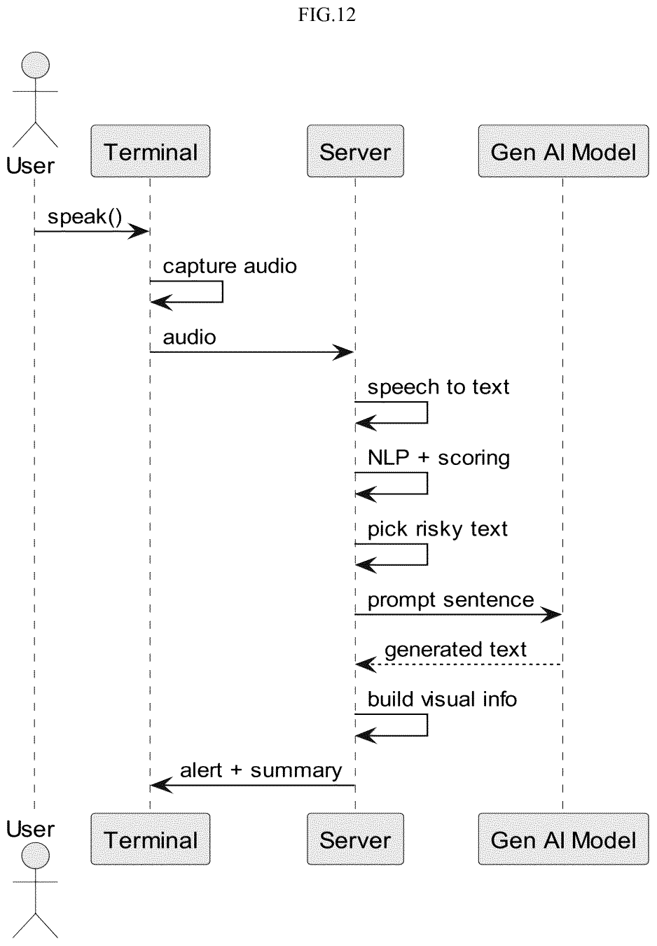

The following describes the processing flow using FIG. 12.

### Step 1:

The user speaks during a workplace conversation while carrying the terminal.

The terminal receives, as input, analog sound waves produced by the user and other persons, through a built-in microphone.

The terminal converts the analog sound into digital audio information by sampling the signal at a predetermined sampling rate and quantizing it into pulse-code-modulated samples using an audio driver and an operating system audio API.

The terminal divides the audio information into fixed-length frames or chunks (for example, 5 seconds) and attaches metadata such as a timestamp, a session identifier, and a device identifier to each chunk, thereby generating structured audio frames as output for further processing.

### Step 2:

The terminal receives, as input, the structured audio frames generated in Step 1.

The terminal performs optional preprocessing on each audio frame, such as noise reduction, normalization of amplitude, and conversion to a compressed audio format, by executing digital signal processing operations implemented in software libraries.

The terminal outputs cleaned and optionally compressed audio frames, with corresponding metadata unchanged, so that the audio is better suited for subsequent speech recognition.

### Step 3:

The terminal receives, as input, the cleaned audio frames and their metadata.

The terminal transmits the audio frames to the server or to a speech recognition service over a communication network using a secure protocol, encapsulating each frame and its metadata into a request message.

The terminal outputs network messages that contain the audio frames, session identifiers, and timestamps, and waits for recognition results.

### Step 4:

The server receives, as input, the network messages containing audio frames from the terminal.

The server reconstructs the audio sequence for each session by ordering the frames according to their timestamps and session identifiers.

The server feeds the audio data into a speech recognition model that computes acoustic features (for example, Mel-frequency cepstral coefficients), applies a neural network (including convolutional and recurrent layers) to estimate phoneme or subword probabilities, and decodes the most likely text sequence using a beam search constrained by a language model.

The server outputs character information (recognized text) for each segment of audio, together with alignment information linking text segments to their timestamps and session identifiers.

### Step 5:

The server receives, as input, the character information and alignment metadata produced in Step 4.

The server structures the character information as analysis target information by grouping text into utterance units, each unit containing raw text, normalized text, timestamp range, and an optional speaker label.

The server stores each utterance unit as a record in a memory or database, and outputs a list of utterance records associated with a conversation identifier.

### Step 6:

The server receives, as input, the list of utterance records generated in Step 5.

The server performs tokenization, morphological analysis, and part-of-speech tagging on the normalized text of each utterance, generating token sequences and grammatical tags by executing a natural language processing library or model.

The server outputs enriched utterance records that include token lists, part-of-speech tags, and basic linguistic features, which serve as input for deeper analysis.

### Step 7:

The server receives, as input, the enriched utterance records from Step 6.

The server applies a syntactic parser, such as a dependency parser implemented by a neural network or rule-based algorithm, to each utterance, computing syntactic relations between tokens (for example, subject-verb, modifier-head).

The server augments each utterance record with dependency structures and syntactic roles, and outputs syntactically annotated utterance records.

### Step 8:

The server receives, as input, the syntactically annotated utterance records.

The server generates feature vectors for each utterance by combining multiple representations, including bag-of-words counts, n-gram indicators, syntactic pattern features, and contextual embeddings produced by a transformer-based encoder.

The server performs numerical operations, such as matrix multiplications and non-linear activations, to map token sequences into dense vector spaces, and outputs a feature vector for each utterance and optionally an aggregated feature vector for the overall conversation.

### Step 9:

The server receives, as input, the feature vectors and utterance records from Step 8.

The server performs emotion analysis by feeding the feature vectors into a sentiment classification model that outputs a sentiment score (for example, between −1 and +1) and an intensity value.

The server records, for each utterance and for the conversation as a whole, the sentiment scores as additional fields in the utterance records, and outputs these augmented records.

### Step 10:

The server receives, as input, the feature vectors and sentiment-augmented utterance records.

The server executes a harassment classification model that computes probabilities for harassment-related categories by applying a neural network or other classifier to the feature vectors.

The server calculates, for each utterance and for the conversation, a harassment probability value and a set of category scores (for example, power harassment, sexual harassment), and outputs updated utterance records including these probability values.

### Step 11:

The server receives, as input, the updated utterance records containing text, linguistic annotations, sentiment scores, and harassment probabilities.

The server performs keyword extraction by computing importance scores for tokens and phrases, using a combination of term frequency-inverse document frequency, attention weights from the classifier, and syntactic prominence (such as head words or modifiers of personal pronouns).

The server selects tokens and phrases with importance scores above a threshold as candidate harassment keywords, associates them with their utterances, and outputs utterance records enriched with keyword lists and keyword scores.

### Step 12:

The server receives, as input, the utterance records enriched with sentiment scores, harassment probabilities, and keyword data.

The server computes an evaluation value for each utterance by combining these signals, for example by applying a weighted sum or a small neural network, where the inputs are sentiment scores, harassment probabilities, and aggregated keyword scores.

The server also computes an evaluation value for the entire conversation, for example by averaging or taking the maximum of the utterance-level scores, possibly weighted by duration or speaker role.

The server outputs utterance records and conversation-level records, each including an evaluation value.

### Step 13:

The server receives, as input, the evaluation values and conversation-level records from Step 12.

The server determines a risk level for each conversation by comparing the conversation-level evaluation value to one or more predetermined thresholds stored in memory.

The server assigns discrete labels such as “low,” “medium,” or “high” to each conversation and updates the conversation record with the risk level.

The server outputs conversation records that contain both evaluation values and risk levels.

### Step 14:

The server receives, as input, the utterance records and conversation risk levels.

The server selects utterance units having a high possibility of harassment by ranking the utterance records according to their evaluation values and by optionally filtering for the presence of harassment-indicative keywords.

The server chooses one or more top-ranked utterance records as trigger segments and extracts their text, timestamps, evaluation values, and risk levels, outputting a set of selected utterance units as candidate triggers.

### Step 15:

The server receives, as input, the selected utterance units and their associated scores.

The server constructs a prompt sentence by embedding the text of the trigger segments and their evaluation information into a template that also includes instruction sentences for a generative AI model.

The server concatenates static instruction text with dynamic elements (trigger texts, scores, risk levels) to form a structured prompt, and outputs a completed prompt sentence as a character string.

### Step 16:

The server receives, as input, the prompt sentence generated in Step 15.

The server transmits the prompt sentence to a generative AI model through an inference interface, converting the text into token IDs, passing the token sequence through the model layers, and requesting a generated output sequence with specified parameters such as maximum length and temperature.

The server receives the generated sequence of tokens from the generative AI model, decodes the tokens into text, and outputs generated text that includes at least one of a summary, an explanation, response policies, and educational examples.

### Step 17:

The server receives, as input, the generated text from the generative AI model.

The server structures this text into visual information by parsing headings or markers in the generated content and mapping portions of the text into defined fields such as “Summary,” “Explanation,” “Response steps,” and “Example expressions.”

The server constructs a visual information record containing these structured fields and associates the record with the corresponding conversation identifier, thereby outputting a visual information object suitable for display.

### Step 18:

The server receives, as input, the conversation records with risk levels from Step 13 and the visual information objects from Step 17.

The server checks whether the risk level for each conversation is equal to or greater than a predetermined threshold.

For conversations meeting the condition, the server generates notification information that includes conversation identification information, an excerpt of at least one trigger utterance, the risk level, the occurrence time, and a reference to the visual information object.

The server outputs notification data objects that are ready to be transmitted to management terminals.

### Step 19:

The server receives, as input, the notification data objects generated in Step 18.

The server uses a communication control function to transmit each notification data object to a management terminal, for example by invoking a push notification service or sending a message over a secure messaging channel.

The server outputs network messages containing the notification data, which are delivered to the management terminal for real-time alerting.

### Step 20:

The terminal of the manager receives, as input, the notification data messages from the server.

The terminal extracts the excerpt text, risk level, and reference to visual information, and displays a notification on a graphical user interface, such as a pop-up alert with a brief description and an action button.

The terminal outputs a user-selectable interface element that allows the manager to open a detailed view of the incident.

### Step 21:

The terminal receives, as input, a user interaction from the manager, such as selecting the detailed view.

The terminal sends a request to the server including the conversation identifier or visual information reference contained in the notification data.

The server receives this request, retrieves from memory the associated analysis target information, utterance records, evaluation values, risk levels, prompt sentence, and visual information record, and returns these as a structured response.

The terminal receives the structured response and displays the original text, highlighted trigger segments, computed scores, and the generated visual information on the screen, thereby outputting a comprehensive incident view for the manager.

### Step 22:

The server receives, as input, all intermediate and final data generated in the preceding steps, including analysis target information, feature vectors (optionally), evaluation values, risk levels, prompt sentences, generated texts, visual information records, and notification logs.

The server writes these data elements into persistent storage, linking them by conversation identifiers, utterance identifiers, and timestamps, and indexing them for efficient retrieval and aggregation queries.

The server outputs a consistent, queryable dataset that supports later auditing, statistical analysis, and generation of new prompt sentences for training or educational scenarios.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented harassment detection systems primarily focus on classifying dialogue text as either harassment or non-harassment using general-purpose text classification techniques. Such systems typically output only a binary label or a short free-form explanation. As a result, they do not provide machine-usable structured information that can be directly transformed into effective educational visual content, such as videos or interactive training materials. In addition, conventional systems do not tightly integrate the interaction flow among a terminal, a server-side classifier, and a content generation pipeline in a way that yields consistent, reproducible educational outputs based on the specific context and reasoning for each harassment determination.

From a computer technology standpoint, existing approaches have several technical shortcomings. First, they do not standardize how a dialogue history is converted into a prompt sentence for a generative AI model, leading to inconsistent outputs and inefficient use of computational resources. Second, they often handle the generative AI model output as unstructured text, requiring ad hoc manual post-processing or human intervention to derive training materials, which reduces the scalability and automation of the system. Third, there is no systematic mechanism to structure internal explanatory elements—such as problem utterances, reasons for harassment classification, and recommended countermeasures—into a reusable description that can feed downstream multimedia generation components.

Consequently, it is difficult to automatically generate and manage visual content, including video data or interactive display data, in a stable and repeatable manner.

Furthermore, existing systems do not provide a technical framework for managing storage locations of generated visual content and linking them back to terminals in a way that closely couples the classification result and the corresponding tailored educational materials. This lack of integration leads to fragmented workflows, increased latency, and potential mismatches between the determined harassment context and the presented training content.

Therefore, there is a need for a computer-implemented technique that improves the way dialogue histories are processed, that uses generative AI models in a controlled and structured manner, and that automatically generates and delivers context-specific visual educational information to terminals, thereby enhancing the overall functionality and efficiency of harassment-related training support systems.

The specific processing by the specific processing unit 290 of the data processing device 12 in Example 2 is realized by the following means.

The present invention provides a server comprising a processor configured to receive, via a communication path, evaluation target information including a dialogue history acquired from a terminal; generate, on the basis of the received evaluation target information, a prompt sentence in accordance with generation rules, concatenate the dialogue history with the prompt sentence to generate input data, transmit a determination request including the input data to a generative AI model, and obtain a determination result and reason information indicating whether the dialogue history corresponds to harassment; when the determination result indicates that the dialogue history corresponds to harassment, structure educational explanation information on the basis of the dialogue history and the reason information, and generate visual content description information including the educational explanation information; generate audio data and image data on the basis of the visual content description information, and synthesize the audio data and the image data to generate video data or interactive display data; and manage storage location information of the generated video data or the generated interactive display data, and notify the storage location information to the terminal so as to cause visual information to be presented at the terminal. This enables a technically improved, end-to-end automated workflow in which dialogue histories are consistently formatted into prompt sentences for a generative AI model, in which structured explanatory data is derived from the model's determination, and in which the structured data is programmatically transformed into and distributed as context-specific visual educational content, thereby enhancing reliability, scalability, and usability of computer-based harassment detection and training systems.
The term “processor” refers to a hardware or virtual information processing unit, such as a central processing unit, graphics processing unit, or other programmable execution resource, configured to execute instructions to perform data reception, analysis, generation, and transmission operations.
The term “terminal” refers to an information processing apparatus operated by a user, such as a personal computer, mobile communication device, or other electronic device, that transmits dialogue histories to a server and presents visual information to the user.
The term “communication path” refers to a wired or wireless communication medium or network, including local area networks and wide area networks, through which data is transmitted between the terminal, the server, and external services.
The term “evaluation target information” refers to information including at least a dialogue history and optionally additional metadata, which is to be analyzed to determine whether the dialogue history corresponds to harassment.
The term “dialogue history” refers to text data representing one or more utterances exchanged between two or more participants over time, including speaker identifiers and message content, which is used as an input for harassment determination.
The term “generation rules” refers to predefined or dynamically updated logical conditions and templates that specify how to construct a prompt sentence and associated input data from evaluation target information, including formatting, ordering, and inclusion or exclusion of elements.
The term “prompt sentence” refers to a natural language instruction or query, possibly including constraints and output format specifications, that is provided as part of input data to a generative AI model to control its processing behavior and output.
The term “input data” refers to data provided to a generative AI model, including at least a prompt sentence and the dialogue history, and optionally additional parameters or context, which collectively define a task to be performed by the model.
The term “determination request” refers to a request message transmitted to a generative AI model, the request message including input data and optionally model control parameters, to cause the generative AI model to output a determination result and associated information.
The term “generative AI model” refers to a machine learning model, such as a neural network-based language model, that generates text or other content in response to input data, and that is capable of producing a determination result and explanatory information with respect to a dialogue history.
The term “determination result” refers to data indicating whether a dialogue history corresponds to harassment, including at least a binary or categorical classification and optionally associated confidence values or structured labels.
The term “reason information” refers to explanatory data generated or derived from a generative AI model output, indicating one or more reasons, grounds, or factors that support the determination result for a dialogue history.
The term “harassment” refers to inappropriate behavior expressed in a dialogue history, including but not limited to abuse of power, sexual harassment, or other conduct that may cause psychological or physical distress to a counterpart.
The term “educational explanation information” refers to structured or semi-structured explanatory data that describes, based on a dialogue history and reason information, which parts of the dialogue are problematic, why they are considered harassment, and what countermeasures or appropriate responses are recommended.
The term “visual content description information” refers to data representing a design or script of visual content, including layout structures, section definitions, text elements, and media arrangement instructions, which can be used to generate audio data and image data.
The term “audio data” refers to digital data representing sound, including narration generated from educational explanation information by text-to-speech processing or pre-recorded voice segments, which are to be included in visual content.
The term “image data” refers to digital data representing static or dynamic visual elements, such as background images, text overlays, icons, and diagrams, which are arranged in accordance with visual content description information.
The term “video data” refers to a temporally ordered sequence of image data combined with corresponding audio data, encoded in a digital video format, and configured to present educational visual information about harassment when played back.
The term “interactive display data” refers to digital data representing interactive visual content, such as hypertext documents or multimedia pages, including user-operable elements that allow navigation, selection, or expansion of educational information.
The term “storage location information” refers to information indicating a physical or logical storage position of generated video data or interactive display data, such as a file path, resource identifier, or network address, which allows access to the stored content.
The term “visual information” refers to information perceptible through visual presentation, including video data, image data, and interactive display data, that conveys educational explanations regarding harassment and related countermeasures.
The term “model control parameters” refers to parameter values supplied to a generative AI model, such as temperature, maximum output length, or response format constraints, which influence the behavior and characteristics of the model's output.
The term “natural language processing technology” refers to computational techniques and algorithms for processing human language, including tokenization, normalization, text length control, and other operations applied to dialogue histories prior to input to a generative AI model.

In one embodiment, a server executes a harassment evaluation and educational content generation application on a hardware platform comprising at least one central processing unit, a main memory, a non-volatile storage device, and a network interface controller. The server runs a general-purpose operating system, such as a UNIX-compatible operating system, and exposes an application programming interface over a packet-switched network. The server cooperates with one or more terminals operated by users. Each terminal includes at least one processor, a memory, a display device, an input device, and a communication interface, and runs a web browser or native application capable of transmitting dialogue histories and rendering visual content.

The server stores program modules including a communication module, a dialogue preprocessing module, a prompt construction module, a generative AI client module, a determination interpretation module, a content structuring module, a media generation module, and a storage management module. The server also stores a trained generative AI model, or connection information for accessing a generative AI model hosted on a separate inference device. The generative AI model in one embodiment is a transformer-based neural network language model including multiple self-attention layers, feedforward layers, and layer normalization components. The generative AI model processes sequences of tokenized text and outputs probability distributions over next-token candidates and intermediate representations that are used to derive classification labels and explanatory text.

The server receives, from a terminal, evaluation target information including a dialogue history in text form and optional metadata such as language, domain type, and anonymized role identifiers. The terminal runs a user interface implemented, for example, using a web framework. The terminal transmits a structured message over a secure communication channel to the server. The server parses the message, validates the received text, and stores the dialogue history and associated metadata as records in a structured data store such as a relational database system.

The server applies natural language processing to the dialogue history using the dialogue preprocessing module. The server uses tokenization algorithms compatible with the generative AI model, such as byte pair encoding or unigram subword tokenization, to convert the dialogue history into a sequence of token identifiers. The server performs normalization, including converting line breaks into standardized separators, removing unsupported control characters, and truncating or segmenting the dialogue history based on a maximum token length supported by the generative AI model. The server maintains a data structure that maps each token identifier sequence back to the original character offsets, enabling later highlighting of problematic utterances on the terminal display.

The server constructs a prompt sentence using the prompt construction module. The server applies generation rules stored in a configuration repository. These rules specify, for example, that the prompt sentence should include (i) a role definition for the model, (ii) a classification instruction, (iii) an output format specification, and (iv) an insertion position for the dialogue text. In one example, the server generates a prompt sentence of the following form:
“You are an expert in workplace harassment assessment. Please determine whether the following dialogue history constitutes harassment. Answer ‘YES’ or ‘NO’ at the beginning of your answer and provide a short reason in one or two sentences. Dialogue history:
[dialogue text]”

In another example, the server generates a prompt sentence for obtaining structured output:
“You are an expert in workplace harassment assessment. Given the following dialogue history, output JSON with the fields ‘is_harassment’ (true or false) and ‘reason’ (a one-sentence explanation). Dialogue history:
[dialogue text]”

The server concatenates the prompt sentence and the normalized dialogue history into input data for the generative AI model. The server sets model control parameters, such as temperature, maximum output tokens, and decoding strategy, in a way that minimizes randomness and promotes deterministic classification, for example by setting a low temperature and disabling sampling. The server thus defines a reproducible text classification and explanation task for the generative AI model.

The generative AI model in this embodiment is implemented as a deep transformer network with, for example, several dozen attention layers, each layer comprising multi-head self-attention sublayers and position-wise feedforward sublayers. During inference, the server supplies the tokenized prompt and dialogue history as input to the model. The model computes attention weights between all pairs of tokens, producing contextualized vector representations. The final layer outputs logits over the vocabulary. The server decodes these logits into textual tokens using a deterministic decoding method such as greedy decoding. In an alternative embodiment, the generative AI model is trained in a multi-task manner to simultaneously output a classification label and an explanation, by adding a special classification token and training the model with a combined loss including a cross-entropy loss for the label and a language modeling loss for the explanation.

The server transmits a determination request including the input data and model control parameters to the generative AI model through the generative AI client module. In a cloud-based embodiment, the server transmits a structured request over a secure network connection to an external inference endpoint. In a local embodiment, the server invokes a local inference engine running on a hardware accelerator such as a graphics processing unit.

The server receives a response comprising an output text sequence and, in some embodiments, additional structured fields indicating the classification label and a confidence score.

The server interprets the returned output using the determination interpretation module. When the output is unstructured text, the server applies string analysis rules to detect the leading “YES” or “NO” token, and extracts the subsequent reasoning portion as reason information. When the output is structured, the server decodes the returned fields into an internal representation that includes a binary harassment flag, a reason string, and, optionally, separate indicators for types of harassment such as abuse of authority or sexual harassment.

The server writes the determination result and the reason information back into the data store, associating them with the original dialogue history record.

When the determination result indicates that the dialogue history corresponds to harassment, the server structures educational explanation information using the content structuring module. The server analyzes the dialogue history and the reason information to identify specific utterances and lexical features that contributed to the determination. The server uses a combination of pattern-based feature extraction and attention-weight analysis from the generative AI model to detect phrases related to power imbalance, repeated verbal abuse, threats, or offensive references. The server groups these textual segments into categories including problem utterance information, harassment reason information, and recommended countermeasure action information.

The server organizes the educational explanation information into a logical multi-section structure. For example, the server defines a first section labeled as problematic statements, which lists the extracted utterances; a second section labeled as reasons, which summarizes why these utterances are considered harassment; and a third section labeled as recommendations, which describes possible responses such as documenting incidents, consulting internal support resources, and adjusting communication styles. The server converts this structured representation into visual content description information, including layout instructions such as the order of sections, the mapping of headings to slides or panels, and relative importance scores for use in visual emphasis.

The server generates media content based on the visual content description information using the media generation module. In one embodiment, the server runs a graphics processing library to create image data for each section, drawing titles, bullet lists, and highlighted quotations onto background templates. The server generates audio data from the educational explanation information using a text-to-speech engine that converts the explanation text into digitized speech. The server then combines the image data and audio data using a multimedia processing library to synthesize video data in a standard format such as an encoded moving image file. In another embodiment, the server generates interactive display data, such as a hypertext document with embedded style and script instructions that enable interactive expansion of sections, tooltips, and playback controls on the terminal.

The server manages storage location information for the generated visual content. The server stores the video data or interactive display data in a content repository, which can be a distributed object storage system or a file system. The server assigns a unique resource locator or identifier to each generated content item and records this identifier and associated metadata in the data store. The server then returns the storage location information to the terminal through the communication module, enabling the terminal to retrieve and display the appropriate content corresponding to the harassment determination.

The terminal receives the determination result and the storage location information from the server. The terminal displays a concise indication of the harassment determination, such as a label and a short explanation, and presents a control element that, when operated by the user, retrieves the visual content from the server or content repository. The terminal decodes and renders the video data or interactive display data on the display device, optionally allowing the user to control playback, navigate through sections, or focus on specific problematic statements. The user reviews the content and may input additional dialogue histories or feedback through the terminal.

From a technical perspective, the described server and terminal configuration provides multiple improvements over conventional computer systems. By standardizing the format and structure of the prompt sentence and by constraining model control parameters for harassment evaluation, the server reduces variance in generative AI outputs and improves the reproducibility and precision of harassment determinations. This standardized handling of input and output reduces post-processing complexity and permits the use of deterministic parsers, which in turn reduces computational overhead and execution time.

The server further improves data management by maintaining explicit mappings between dialogue histories, model determinations, structured educational explanation information, and generated media artifacts in a relational data schema. This structured linkage enables efficient retrieval and reuse of content, supports caching of frequently requested educational materials, and allows the server to avoid redundant recomputation when identical or highly similar dialogue histories are evaluated, thereby decreasing processing load and network traffic.

The generative AI model architecture and training approach described above improves classification accuracy and explanation quality relative to simple rule-based systems or generic classifiers. The server uses training data comprising labeled dialogue histories and corresponding explanatory texts. During training, the server or an associated training device optimizes model parameters using gradient-based learning with an error function that combines a cross-entropy term for the classification label and a language modeling term for the explanation. The server may apply data augmentation techniques such as paraphrasing utterances, permuting dialogue order within realistic bounds, and injecting synthetic examples of borderline harassment. These techniques yield a model that is robust to linguistic variation and that can produce coherent, context-sensitive reason information. As a result, the overall system achieves higher detection precision and recall and generates more informative reasons, directly contributing to the quality of educational content.

The server implements specific non-conventional processing flows for extracting explanatory structure from the generative AI output. Instead of merely forwarding a free-form explanation to the user, the server decomposes the explanation into discrete elements using pattern matching, syntactic analysis, and attention-based saliency scoring. The server then maps these elements into predefined structural slots in the visual content description information.

This approach is not a simple automation of human editorial work; it leverages the internal representations and probabilistic scores of the neural network to identify and rank harmful expressions in a manner that would be impractical or inconsistent for a human operator to apply at scale. This contributes to an improvement in the computer's ability to convert unstructured natural language reasoning into machine-usable, structured multimedia generation instructions.

The integration between the generative AI model and the media generation pipeline also yields a technical effect in terms of execution efficiency and resource usage. Because the server structures educational information into a compact description before media generation, the server can pre-compute reusable components, such as background templates and generic recommendation blocks, and only render variable overlays and audio segments that depend on the specific dialogue history. This modular rendering strategy reduces the amount of image processing and audio generation required per case, which in turn decreases processor utilization and shortens response time experienced by the user.

In addition, the server uses scheduling and caching strategies within the storage management module to balance computational load. For example, when multiple terminals request educational content for dialogue histories that have similar harassment patterns and reason structures, the server can reuse previously generated visual content or partially reused assets, serving them by reference rather than regenerating them. This adaptation of content generation to the pattern space of determinations reduces redundant processing and conserves network bandwidth, representing an improvement in the efficiency of the computer system as a whole.

The described system is not limited to a single type of generative AI model. In alternative embodiments, the server uses a smaller classification-oriented neural network, such as a fine-tuned encoder-only transformer, for the harassment determination, and a larger decoder-only generative model for explanation and script generation. In another embodiment, the server uses a hybrid model in which a rule-based filter first flags obvious non-harassment or non-relevant cases, and only borderline cases are passed to a transformer-based generative AI model for detailed reasoning. These variations allow the server to trade off computational cost and accuracy according to deployment constraints, while maintaining the core structure of prompt-based determination and structured content generation.

In further embodiments, the server uses different visual content formats, such as slide sequences, interactive diagrams, or adaptive questionnaires, but maintains the principle of deriving these from visual content description information generated by the content structuring module. The server can extend the educational explanation information to include localized language versions or industry-specific guidelines, which are applied by inserting additional instruction segments into the prompt sentence. For example, the server may use a prompt sentence such as:
“Please determine whether the following dialogue history constitutes harassment under general workplace guidelines, and then generate a short explanation suitable for training employees in a corporate environment. Dialogue history:
[dialogue text]”

By configuring the prompt sentence and generative AI model in this way, the server can automatically adapt educational content to different regulatory or cultural contexts while preserving the same technical processing framework.

The described embodiments show how the server, terminal, and generative AI model cooperate through specific data structures, algorithms, and processing sequences to achieve improved computer functionality. The system provides not only automated harassment detection but also technically structured transformation of dialogue histories into reproducible, machine-generated educational media. This yields technical effects including improved processing speed, increased detection and explanation accuracy, reduced computational and communication resource usage, and enhanced manageability of multimedia training content within a networked computer environment.

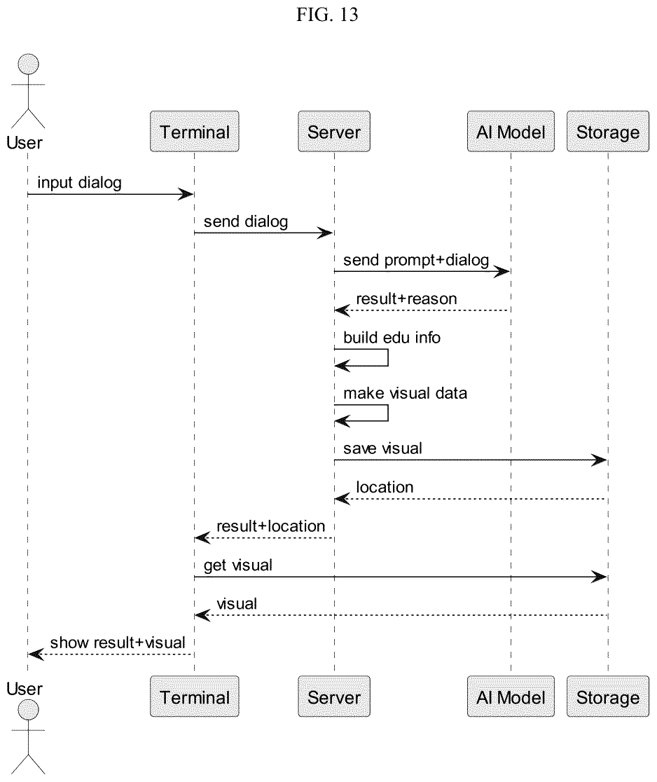

The following describes the processing flow using FIG. 13.

### Step 1:

The user operates the terminal to input a dialogue history. The terminal presents an input screen with a text area and optional fields such as language and scenario type. The user types or pastes a sequence of utterances, for example a conversation between a manager and an employee, and then triggers a send command. The input of this step is raw natural-language text entered by the user. The terminal validates that the text is not empty and within a defined length limit, and converts the text and metadata into an internal data structure. The output of this step is validated dialogue text and metadata held in the terminal's memory.

### Step 2:

The terminal transmits the validated dialogue history to the server. The terminal packages the dialogue text and metadata into a structured message and sends it to the server over a secure communication channel. The input of this step is the validated dialogue text and associated metadata, and the output is a network message carrying evaluation target information addressed to the server.

### Step 3:

The server receives the evaluation target information from the terminal. The server's communication module parses the received message and extracts fields including user identifier, dialogue text, and metadata. The input of this step is the network message from the terminal, and the output is an internal record that stores the dialogue history and metadata in a structured format in the server memory.

### Step 4:

The server stores the received dialogue history in a persistent data store. The server assigns a unique identifier to the record and writes the dialogue text, metadata, and timestamp into a database. The input of this step is the internal record containing the dialogue history, and the output is a stored database entry that can be referenced by the unique identifier for subsequent processing.

### Step 5:

The server preprocesses the dialogue history using natural language processing. The server retrieves the dialogue text from the database, normalizes line breaks and whitespace, removes unsupported control characters, and applies tokenization compatible with the generative AI model. The input of this step is the stored dialogue text, and the output is a normalized text string and a corresponding sequence of token identifiers together with a mapping from token indices to character positions.

### Step 6:

The server generates a prompt sentence according to predefined generation rules. The server consults a configuration that specifies prompt templates, role descriptions, and required output format. Based on the selected template, the server constructs a prompt sentence such as:
“You are an expert in workplace harassment assessment. Please determine whether the following dialogue history constitutes harassment. Answer ‘YES’ or ‘NO’ at the beginning of your answer and provide a short reason in one or two sentences. Dialogue history:”

The input of this step is the normalized dialogue text and the configuration of generation rules, and the output is a complete prompt sentence ready to be combined with the dialogue text.

### Step 7:

The server constructs input data for the generative AI model. The server concatenates the prompt sentence and the normalized dialogue text, inserts any necessary separators, and sets model control parameters such as temperature and maximum output tokens. The input of this step is the generated prompt sentence and normalized dialogue text, and the output is a structured model input that includes the combined text and control parameters.

### Step 8:

The server transmits a determination request to the generative AI model. The server's generative AI client module formats the model input into a request compatible with the model interface and sends it to the model, either locally or over a network to an inference service. The input of this step is the structured model input, and the output is a determination request in transit to the generative AI model.

### Step 9:

The generative AI model processes the determination request and returns an output to the server. The server does not change the model internals but invokes the model and waits for completion. The returned data typically contains a text sequence including an explicit “YES” or “NO” and a human-readable reason, or a structured representation with an “is_harassment” flag and “reason” string. The input of this step, from the server point of view, is the determination request sent previously, and the output is a model response containing a determination result and explanatory text.

### Step 10:

The server interprets the generative AI model output and derives a harassment flag and reason information. The server parses the returned text or structured data, detects the classification portion, and sets a Boolean harassment flag. The server also extracts the explanatory portion and stores it as reason information. The input of this step is the model response, and the output is an interpreted determination result consisting of an internal harassment flag and associated reason text linked to the dialogue record.

### Step 11:

The server updates the database with the determination result. The server writes the harassment flag, reason information, and model identifier into the dialogue record, and changes the record status to indicate that classification has been completed. The input of this step is the interpreted determination result and the record identifier, and the output is an updated database record that associates the original dialogue with the determination and explanation.

### Step 12:

The server decides whether to generate educational visual content based on the harassment flag. If the harassment flag is false, the server may skip targeted content generation or select generic educational content. If the harassment flag is true, the server passes the dialogue text and reason information to the content structuring module. The input of this step is the harassment flag and associated record data, and the output is a decision signal and a set of input data for content structuring.

### Step 13:

The server structures educational explanation information. The server analyzes the dialogue text and reason information to identify specific problematic utterances, such as repeated insults or threats, and categorizes them into problem utterance information, harassment reason information, and recommended countermeasure action information. The input of this step is the dialogue text and reason information, and the output is a structured explanation object that organizes these elements into labeled categories.

### Step 14:

The server generates visual content description information. The server converts the structured explanation object into a multi-section layout that defines headings, bullet points, highlighted quotes, and recommendation lists, along with ordering and emphasis levels. The input of this step is the structured explanation object, and the output is visual content description information that specifies how to arrange text and media components in visual content.

### Step 15:

The server generates image data based on the visual content description information. The server uses a graphics library to render background templates, titles, and text blocks for each section, and highlights specific dialogue passages. The input of this step is the visual content description information, and the output is a set of image data elements representing slides or panels for the educational content.

### Step 16:

The server generates audio data from the educational explanation information. The server selects or synthesizes narration by applying a text-to-speech engine to the explanation text, creating a digital audio stream that follows the structure of the sections. The input of this step is the educational explanation text derived from the structured explanation object, and the output is audio data suitable for synchronization with the image data.

### Step 17:

The server synthesizes video data or interactive display data from the image and audio data. For video, the server combines sequential image frames with the audio track using a multimedia processing tool to produce a playable video file. For interactive content, the server generates a hypertext document that arranges the images and explanatory text with interactive controls. The input of this step is the set of image data and audio data, and the output is either encoded video data or interactive display data representing the complete educational content.

### Step 18:

The server stores the generated visual content and manages storage location information. The server writes the video data or interactive display data to a storage system, generates a unique resource locator or identifier, and records this locator along with metadata in the database. The input of this step is the generated visual content data, and the output is storage location information permanently associated with the corresponding dialogue record.

### Step 19:

The server transmits the determination result and storage location information to the terminal. The server constructs a response that includes the harassment flag, a summary reason, and a link or identifier for the visual content. The input of this step is the updated dialogue record including the storage location information, and the output is a response message addressed to the terminal.

### Step 20:

The terminal receives the response from the server and prepares a display for the user. The terminal parses the response, extracts the harassment determination, reason text, and visual content locator, and updates the user interface to show the determination result and a control element to access the educational content. The input of this step is the response message from the server, and the output is a rendered user interface state containing the determination and an entry point to the visual content.

### Step 21:

The user operates the terminal to view the educational content. The user activates the control element, causing the terminal to retrieve the visual content from the server or content repository using the storage location information. The input of this step is the control element and the associated locator, and the output is a media request sent to the content source.

### Step 22:

The terminal obtains and renders the visual content for the user. The terminal downloads or streams the video data or interactive display data using the provided locator, decodes the media, and presents it on the display with appropriate controls for playback or interaction. The input of this step is the visual content data retrieved from storage, and the output is a continuous visual and, when applicable, audio presentation that the user can perceive and interact with.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional harassment detection systems that operate on conversation logs typically rely on static keyword lists or simple sentiment scores. Such systems suffer from multiple technical limitations. First, they perform text analysis in a monolithic manner, without structured preprocessing or explicit integration of linguistic features and emotion features, which leads to low discrimination accuracy between benign negative feedback and actual harassment. Second, they do not generate machine-targeted, structured prompt sentences for downstream generative models; instead, they pass raw or loosely formatted text to a generative model, which causes non-deterministic outputs, unstable quality of explanations, and inconsistent scenarios for visual feedback. Third, existing solutions do not tightly couple the harassment determination logic with automatic generation of visual content, such as educational videos, in a unified processing pipeline, resulting in fragmented workflows with high latency, substantial manual intervention, and limited scalability. Fourth, feedback from end users regarding the usefulness or accuracy of generated outputs is not systematically used to adapt the prompts or instructions to the generative model, so the system cannot effectively learn from deployment-time data and cannot continuously improve its behavior.

From a computer-technology standpoint, there is a need for a technical mechanism that: (i) structures and preprocesses conversation data in a way that is optimized for downstream harassment detection and generative processing, (ii) combines harassment indicators and emotion indicators to compute an adjusted harassment determination, (iii) converts such adjusted determinations and problem portions of the conversation into machine-oriented prompt sentences tailored for a generative AI model, and (iv) automatically transforms the resulting text information into visual information with minimal human intervention. In addition, there is a need to technically close the loop by incorporating user evaluation information into the generation rules of the prompt sentences and instruction content to the generative AI model, so that the overall computing pipeline dynamically adapts and improves over time. Without such integrated mechanisms, harassment analysis and educational content generation remain inaccurate, brittle, resource-inefficient, and difficult to maintain or extend in production computing environments.

The specific processing by the specific processing unit 290 of the data processing device 12 in Application Example 2 is realized by the following means.

The present invention provides a server comprising a processor configured to acquire conversation history, perform preprocessing and language analysis to calculate harassment indicators and emotion indicators, adjust a harassment determination result on the basis of the emotion indicators, generate a structured prompt sentence including harassment content, recipient emotion, alternative expressions, and components of educational visual content, supply the prompt sentence to a generative AI model to obtain text information including an explanation of the harassment and a scenario of visual content, and automatically generate visual information by using a visual content generation program on the basis of the text information, and further to update generation rules of the prompt sentence and instruction content to the generative AI model on the basis of user evaluation information. This enables a technically improved end-to-end harassment analysis and feedback pipeline in which conversation data are normalized and enriched for machine processing, harassment determinations are refined by explicit emotion integration, prompt sentences are systematically optimized for generative AI interaction, visual educational content is produced automatically and consistently, and the overall system behavior is adaptively improved through feedback-driven updates to prompting logic.
The term “conversation history” refers to digital data representing at least one sequence of utterances exchanged between one or more participants, the data being stored in a machine-readable form such as text obtained directly from user input or text converted from audio signals.
The term “harassment” refers to a pattern or instance of communication in which one participant directs inappropriate, abusive, or oppressive expressions toward another participant, including but not limited to excessive criticism, insults, intimidation, or other conduct that is likely to cause psychological harm.
The term “harassment indicator” refers to a feature value or metric derived from conversation history by computational analysis, the feature value representing the likelihood or degree to which a portion of the conversation history corresponds to harassment.
The term “emotion indicator” refers to a feature value or metric derived from conversation history or associated audio data by computational analysis, the feature value representing an estimated emotional state such as anger, frustration, sadness, or joy and an intensity of that emotional state.
The term “language analysis” refers to automated processing performed on conversation history using linguistic techniques including at least one of tokenization, morphological analysis, syntactic analysis, semantic analysis, and discourse analysis in order to extract structural and semantic information.
The term “morphological analysis” refers to automated processing that segments text into tokens and identifies grammatical attributes of the tokens, such as part-of-speech, lemma, or inflectional form, for use in subsequent computational analysis.
The term “syntactic analysis” refers to automated processing that determines grammatical relationships among tokens in text, including at least one of dependency relationships, phrase structures, and clause boundaries, for use in subsequent computational analysis.
The term “emotion analysis” refers to automated processing that estimates one or more emotional states from conversation history or associated audio data, by applying at least one of sentiment analysis, emotion classification, or prosody analysis.
The term “harassment determination result” refers to data representing an outcome of computational evaluation of conversation history with respect to harassment, including at least an indication of whether harassment is present and optionally a confidence value or probability.
The term “adjusted harassment determination result” refers to a harassment determination result that has been modified by incorporating emotion indicators or other contextual indicators so as to strengthen, weaken, or refine an initial harassment determination.
The term “problem portion” refers to at least one segment of conversation history, such as a sentence, phrase, or utterance, that has been identified by computational analysis as contributing to a harassment determination.
The term “prompt sentence” refers to a machine-readable instruction text generated for input to a generative AI model, the instruction text specifying at least context information, problem portions, desired output types, and constraints so as to control the content and structure of model output.
The term “generative AI model” refers to a computational model implemented by software and hardware that generates new data, such as natural-language text or visual content descriptions, in response to input data including a prompt sentence.
The term “text information” refers to digital information represented as natural-language text or structured text that is generated by the generative AI model, including at least explanations, alternative expressions, and scenarios for visual content.
The term “visual information” refers to digital content intended for visual presentation to a user, including at least one of moving image data, still image data, graphical layouts, slide sequences, or any combination thereof.
The term “visual content generation program” refers to software that creates or edits visual information on the basis of text information, the software including at least one of a video editing program, an image generation program, a slide generation program, or a script-controlled multimedia rendering library.
The term “video editing program” refers to software that constructs or modifies time-based visual media by arranging visual elements, text overlays, audio tracks, and transitions on a timeline to generate a video file.
The term “image generation program” refers to software that generates still images or graphics from input data, including at least one of template-based rendering programs and image synthesis models.
The term “terminal” refers to an information processing apparatus operated by a user, including at least one of a portable communication device, a wearable device, a personal computer, or a stationary display device, and configured to transmit conversation history to a server and to present visual information to the user.
The term “user evaluation information” refers to data received from a terminal and indicating a user's assessment of generated visual information, the data including at least one of ratings, selection inputs, or free-form comments.
The term “generation rule of the prompt sentence” refers to configuration data or control logic that specifies how analysis results, harassment indicators, emotion indicators, and problem portions are combined and formatted when constructing the prompt sentence.
The term “instruction content to the generative AI model” refers to portions of the prompt sentence or associated parameters that define desired behavior of the generative AI model, including requested output types, level of detail, tone, structure, and constraints on generated content.

In one embodiment, a server, one or more terminals, and one or more users cooperate to implement the system. The server comprises at least one processor, a memory storing program instructions and data structures, and one or more communication interfaces connected to a network. The terminal comprises a processing unit, a user interface including at least a display and input controls, and optionally a microphone and speaker. The user operates the terminal to provide conversation history and to view visual information generated by the server.

The server executes a program that implements a harassment analysis and visual feedback pipeline. The server program is stored in a non-transitory computer-readable medium in the memory and is executed by the processor. The server program uses software components including a natural language processing library (for example, a library of the same class as spaCy or NLTK), a sentiment and emotion analysis engine (for example, a cloud-based natural language analysis service such as a generic cloud NLP API), a generative AI model accessed via an API (for example, a transformer-based large language model of the GPT type), and a visual content generation program (for example, a video editing engine of the same class as a non-linear editor or a script-controlled multimedia rendering library such as MoviePy-class software).

The server maintains data structures for conversation history and analysis results. In one example, the server stores each conversation history as a record in a relational database, where the record contains a conversation identifier, a user identifier, a timestamp, and a text field storing a sequence of utterances. The server also stores associated analysis results as structured records including harassment indicators, emotion indicators, an adjusted harassment determination result, and references to generated visual information. The harassment indicators may be represented as numeric scores in a fixed-length feature vector, where each element corresponds to a specific pattern such as frequency of insulting terms, ratio of negative sentiment sentences, or presence of power-imbalanced directives. The emotion indicators may be represented as numeric values for dimensions such as anger, sadness, and joy, computed per sentence and aggregated over the conversation.

The server uses a language analysis pipeline to process conversation history. The server loads text from the conversation record into memory and applies linguistic preprocessing by calling functions of the natural language processing library. The server performs tokenization, sentence segmentation, morphological analysis, and syntactic analysis. For example, the server calls a tokenizer that divides a character sequence into tokens, calls a part-of-speech tagger that assigns grammatical categories to each token, and calls a dependency parser that constructs a directed graph representing grammatical relations between tokens. By representing the conversation as a graph and a token sequence, the server can compute harassment indicators that are sensitive to both lexical content and syntactic context.

The server computes harassment indicators by applying rule-based logic and machine-learned classification on the language analysis results. For instance, the server may maintain a table of weighted patterns, where each pattern is defined by a combination of lexical features (such as presence of an insult term) and syntactic roles (such as second-person subject followed by a negative predicate). The server computes a score by summing weights of matched patterns over the conversation. In addition, the server may use a trained classifier such as a linear or neural classifier that takes a feature vector as input. The feature vector may include term frequency-inverse document frequency values, dependency relation counts, and sentiment values. The classifier outputs a probability that the conversation contains harassment. The server stores this probability as a harassment indicator.

The server computes emotion indicators by calling the emotion analysis engine. The server sends sentence-level text to the engine and receives sentiment scores and emotion labels. In a more specific embodiment, the emotion engine is implemented as a neural network classifier, for example a bidirectional recurrent network or a transformer encoder with an output layer trained to predict emotion labels. The server constructs an input vector for each sentence by mapping tokens to embeddings, applying the neural encoder, and then applying a softmax output layer to produce probabilities over emotions. The server combines these probabilities into numeric indicators, such as an anger score between 0 and 1, for each sentence and for the entire conversation. The server writes these indicators into the analysis record.

The server adjusts a harassment determination result based on emotion indicators. The server first derives an initial harassment determination from the harassment indicators; for example, the server compares the harassment probability with a threshold. The server then examines emotion indicators; when the anger score or similar negative emotion score exceeds a specified threshold and coincides with problem portions identified by the harassment indicators, the server increases the effective harassment probability or lowers the threshold.

This adjustment is performed through a deterministic rule or a learned calibration function. Because the server explicitly combines two heterogeneous feature sets (linguistic structure and emotion state), the server can resolve ambiguous cases where purely lexical analysis would either miss harassment or over-flag non-harassing strong feedback. This combined adjustment improves detection precision and recall and reduces false positives and false negatives, which constitutes an improvement of the technical performance of the text classification pipeline.

The server generates a structured prompt sentence for interaction with a generative AI model.

The server uses a prompt construction module that receives as inputs: the adjusted harassment determination result, a list of problem portions (for example, specific sentences that triggered high harassment indicators), emotion indicators for those portions, and contextual metadata such as the communication setting. The server formats these inputs into a machine-readable natural language instruction. The server applies a rule-based template system, where each template defines slots for: conversation context, explicit quote of problem portions, description of detected emotions, required output sections, and constraints (for example, output length, tone). Because the server uses structured templates and includes explicit technical constraints, the server can control the behavior of the generative AI model with higher reproducibility than passing raw text alone. The prompt sentence is thus not merely a human-authored instruction but a dynamically computed control sequence that encodes analysis results into a form optimized for a transformer-based generative model.

In one concrete example, the server generates the following prompt sentence for an educational video:
“This conversation has been judged as workplace harassment.
Context: manager talking to subordinate in an office.
Conversation:
‘You are always late. You are useless if you cannot do such a simple task.’
Detected emotions: high anger and high frustration from the speaker.
1. Explain in simple terms why these expressions are considered harassment.
2. Describe how the recipient might feel.
3. Propose several polite and constructive alternative expressions.
4. Write a script for a 60-second educational video that illustrates the problem and shows better ways to speak.”

In another example, when the user wants to check a past meeting, the server generates a prompt sentence:
“Analyze the following meeting transcript and evaluate the possibility of harassment.
Highlight any sentences that may be considered workplace harassment and explain why.
Then propose concrete behavioral improvements.
Transcript:
‘. . . [meeting text]. . . ’”

The server supplies the prompt sentence to a generative AI model. The generative AI model may be a transformer-based language model comprising an encoder-decoder or decoder-only architecture with multiple self-attention layers, feed-forward layers, layer normalization, and learned token embeddings. The model parameters are learned offline via gradient-based optimization on large text corpora, using an objective such as next-token prediction (cross-entropy loss), and possibly fine-tuned on instruction-following or dialogue datasets.

During inference, the server tokenizes the prompt sentence, maps tokens to embeddings, performs multi-head attention and feed-forward computations layer by layer, and generates output tokens according to a decoding strategy such as greedy decoding or temperature-controlled sampling. Although training is performed prior to deployment, the server still controls runtime behavior via the structure and content of the prompt sentence and additional parameters such as maximum token length and sampling temperature.

The server parses the output text generated by the generative AI model into logical sections.

The server identifies, for instance, a section that explains why certain statements are harassment, a section that proposes alternative expressions, and a section that describes a video scenario. To facilitate parsing, the server can instruct the generative AI model in the prompt sentence to label sections with markers such as “Explanation:”, “Alternatives:”, and “Video script:”. The server splits the generated text based on such markers and stores the parts in corresponding fields of an output data structure.

The server then generates visual information on the basis of the text information. In one embodiment, the server uses a video content generation program. The server converts the video script into a sequence of scenes, each scene having attributes such as duration, background style, text overlays, and optional narration text. The server writes these attributes into a timeline structure and passes this structure to the video editing program. The video editing program composes the scenes into a video file by placing background images, overlaying text, and optionally generating synthetic narration with a text-to-speech engine. In another embodiment, the server uses an image generation program to create static images or slides representing key points; for instance, the server creates a slide with the original problematic statement, a slide with the reason it is problematic, and a slide with improved phrasing.

The server transmits the generated visual information to a terminal. In one configuration, the server stores the video file on a storage device and generates a uniform resource locator for the file. The server sends a response to the terminal including the uniform resource locator and metadata such as video length and recommended display mode. The terminal retrieves the file via a network protocol and plays the video on the display for the user. Because the server pre-computes and encodes visual information in a compressed video or image format, the amount of data transmitted is bounded and predictable, which reduces communication load compared to streaming raw high-resolution frame sequences or continuous screen-sharing.

In another embodiment, the server receives conversation history as audio data instead of text.

The terminal captures audio through a microphone and sends the audio stream to the server.

The server invokes a speech recognition program executed on the server or on an external speech recognition service. The speech recognition program applies acoustic modeling and language modeling to convert the audio waveform into text. The server stores the resulting text as conversation history and subjects it to the same language analysis and harassment determination processing as described above. By centralizing speech recognition at the server, the system can use more accurate and resource-intensive models that would be infeasible to run on a low-power terminal.

In a further embodiment, the server updates the generation rules of the prompt sentence and the instruction content to the generative AI model based on user evaluation information. After the user views the visual information on the terminal, the user may provide evaluation through the user interface, such as selecting whether the content was helpful or entering comments about accuracy. The terminal sends this evaluation to the server as structured data.

The server aggregates evaluation data across users and identifies patterns, for example that certain prompt templates yield more useful visual information than others or that some sections requested in the prompt are rarely used. The server modifies template parameters, such as weights for including emotional details, requested output length, or level of explanation detail, based on the aggregated evaluation. The server may also use a reinforcement learning approach in which the evaluation serves as a reward signal for adjusting prompt construction rules. This feedback loop represents a technical mechanism for improving system behavior over time without retraining the generative AI model itself, and it optimizes server-side resource usage and output quality.

From a computer-technology perspective, the described embodiments provide several technical effects beyond mere automation of human review. The explicit separation between language analysis, harassment indicator computation, emotion indicator computation, adjusted determination, and prompt construction yields improved computational efficiency.

The server avoids repeatedly sending long raw transcripts to the generative AI model; instead, the server summarizes relevant problem portions and emotion context into compact prompt sentences. This reduces the number of tokens processed by the generative AI model, which improves throughput and lowers inference latency. By integrating emotion indicators into the harassment determination, the server reduces the need to re-invoke the generative model for borderline cases, thereby saving computational cycles.

The server's use of structured prompt sentences and template-based instruction content improves determinism and reduces variance in generated outputs. Unlike ad-hoc textual instructions, the prompt sentences are systematically generated from defined data structures, which aligns model behavior with specific technical requirements such as including scene boundaries or labeling explanation sections. This alignment allows the server to parse and post-process generated text more reliably, which reduces error propagation into the visual content generation stage. As a result, the server can automatically generate consistent and machine-processable visual scripts, which enables automated video generation without manual editing.

The described system also improves data management. By storing conversation history, harassment indicators, emotion indicators, and generated visual information in linked records, the server can perform indexed queries, track history, and support auditing. This data organization enables efficient re-analysis with updated models or thresholds and allows the system to cache and reuse visual content when similar harassment patterns occur. The caching reduces redundant calls to the generative AI model and the video editing program, thereby lowering processing load.

The server uses algorithmic rules that differ from typical human reasoning. For example, the server may compute a harassment score as a weighted sum of syntactic pattern counts and emotion intensities, where weights are optimized via supervised learning with an objective of minimizing a loss function that penalizes mismatches with annotated ground truth. The server may use gradient descent to update these weights during an offline training phase. The resulting decision boundary may differ from intuitive human categories but is tailored to maximize classification accuracy on large corpora. This non-intuitive weighting and combination of features represent a machine-specific method that is not a simple codification of human heuristics.

In another implementation variation, the generative AI model is fine-tuned on a dataset of harassment cases and corresponding explanations and video scripts. The server uses a training procedure in which the model parameters are updated by back-propagation of gradients through multiple layers, using a token-level cross-entropy loss. During training, the server may apply data augmentation techniques such as paraphrasing sentences, injecting synthetic noise, or masking segments to make the model robust. The trained model is then deployed for inference in the server. Although the internal workings of the neural network are complex, the server controls the inputs (prompt sentences) and interprets the outputs through deterministic parsing and mapping to visual content structures, thereby harnessing the model in a way that is technically constrained and optimized for the system's pipeline.

Alternative embodiments can modify hardware and software components while preserving the essential technical characteristics. In one alternative, the terminal performs part of the language analysis locally to reduce server load; for example, the terminal may perform tokenization and initial sentiment analysis, and transmit intermediate representations to the server. In another alternative, the server generates static image-based visual information instead of full-motion video, by calling an image generation program that synthesizes symbolic scenes illustrating harassment patterns. In yet another alternative, the emotion analysis is performed on audio features instead of text, using a neural network trained on prosodic features; the server incorporates these audio-based emotion indicators into the harassment determination and prompt construction in the same manner.

Through these embodiments, the server, the terminal, and the user cooperate to implement a system in which conversation history is transformed, via specific computational steps and specialized data structures, into adjusted harassment determinations, structured prompt sentences, and automatically generated visual information. The technical configuration of the server and the described software modules yields improvements in accuracy, processing speed, communication efficiency, and reliability of the harassment analysis and feedback pipeline, and therefore constitutes an improvement in computer-implemented text and media processing technology.

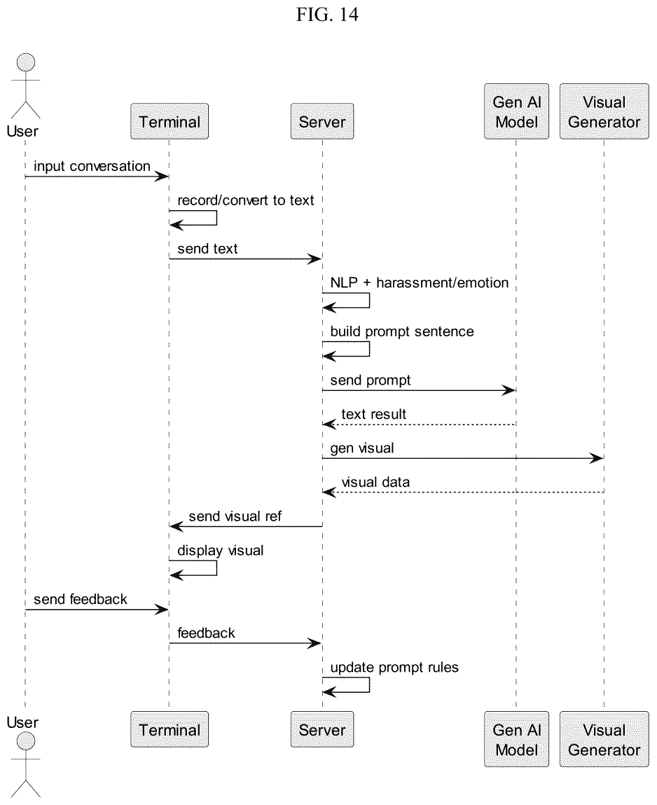

The following describes the processing flow using FIG. 14.

### Step 1:

User operates the terminal to provide conversation data.

User selects a function in an application on the terminal to either start recording a conversation or input past conversation text. As input, the user provides spoken utterances captured by a microphone or text pasted into an input field. Based on this input, the terminal creates a conversation data object that includes at least a user identifier, a timestamp, and either an audio stream or a text string. The output of this step is the conversation data object stored temporarily in the terminal.

### Step 2:

Terminal converts audio to text when necessary.

Terminal checks whether the conversation data object contains audio data. If audio is present, the terminal calls a speech recognition program or a network speech recognition service and transmits the audio waveform as input. The speech recognition program performs acoustic feature extraction and language model decoding, and outputs a text transcript of the spoken conversation. The terminal replaces the audio portion of the conversation data object with the transcript and adds language and confidence metadata. The output of this step is a conversation data object containing normalized text as conversation history.

### Step 3:

Terminal transmits conversation history to the server.

Terminal packages the conversation history text, the user identifier, timestamps, and device metadata into a request message. As input, the terminal uses the conversation data object from Step 2 or the original text entered by the user. The terminal serializes this information into a structured format such as a JSON payload and sends it via a network interface to an API endpoint of the server. The output of this step is a network request delivered to the server containing the conversation history and associated metadata.

### Step 4:

Server receives and stores the conversation history.

Server listens on the API endpoint and receives the request message from the terminal as input. Server parses the payload to extract the conversation history text, user identifier, and timestamps. Server writes these values into a storage system as a new conversation record, assigning a unique conversation identifier and initializing fields for analysis results. The data processing consists of parsing structured data, validating required fields, and inserting a record into persistent storage. The output of this step is a stored conversation record referenced by the conversation identifier.

### Step 5:

Server performs text preprocessing and language analysis.

Server retrieves the conversation history text from the stored conversation record using the conversation identifier as input. Server runs a language analysis module that performs whitespace normalization, sentence segmentation, tokenization, morphological analysis, and syntactic parsing. The server uses a natural language processing library to compute part-of-speech tags and dependency relations for each token. These operations convert the raw text into structured linguistic representations, such as token lists and dependency graphs.

The output of this step is a language analysis result object containing sentences, tokens, grammatical attributes, and syntactic structures.

### Step 6:

Server computes harassment indicators from linguistic features.

Server uses the language analysis result object as input. Server applies a set of rules and trained models to identify patterns associated with harassment, such as personal attacks, repeated negative qualifiers, or commands directed at a second person. Server counts occurrences of these patterns, computes frequencies, and maps them into a numeric feature vector. Server optionally applies a statistical or neural classifier to this feature vector to compute a harassment probability. The data processing includes feature extraction, weighted summation, and classifier inference. The output of this step is a harassment indicator set, including at least a global harassment score and per-sentence scores or flags.

### Step 7:

Server computes emotion indicators for the conversation.

Server takes the original text and optionally the language analysis result as input to an emotion analysis module. Server segments the text into sentences and sends each sentence to an emotion analysis engine or executes a local emotion classifier. The classifier computes sentiment polarity and emotion probabilities (for example, anger, sadness, joy) using learned model parameters. Server aggregates these values across sentences to derive emotion intensity scores per emotion type. The data processing includes mapping sentence text to embeddings, computing network outputs, and aggregating scores. The output of this step is an emotion indicator set containing per-sentence emotion labels and global emotion scores.

### Step 8:

Server adjusts the harassment determination using emotion indicators.

Server uses the harassment indicator set and emotion indicator set as input. Server calculates an initial harassment determination by comparing the harassment score to a threshold. Server then adjusts this determination by applying rules that consider emotion intensity; for example, when the anger score exceeds a predefined value for sentences flagged as problematic, the server increases the harassment score or lowers the threshold. The processing consists of evaluating conditional rules or applying a calibration function that combines harassment and emotion scores into a single adjusted score. The output of this step is an adjusted harassment determination result that includes a final harassment status, a confidence value, and a list of problem portions.

### Step 9:

Server extracts problem portions from the conversation history.

Server uses the adjusted harassment determination result and the language analysis result as input. Server identifies sentences or phrases whose harassment scores exceed a per-sentence threshold or that correspond to specific harassment patterns. Server reads the original text spans from the conversation history and associates them with their positions and emotion labels. The data processing involves cross-referencing indices from analysis structures with segments of the original text. The output of this step is a problem portion list that contains text segments, their positions, and associated emotion indicators.

### Step 10:

Server constructs a structured prompt sentence for the generative AI model.

Server takes as input the adjusted harassment determination result, the problem portion list, and context metadata such as communication type. Server selects a prompt template appropriate for the scenario, for example an educational video template or a self-check template. Server fills template slots with the conversation context, quoted problem portions, detected emotions, and explicit instructions about desired outputs. The server concatenates these components into a single natural-language instruction string. The data processing includes string formatting, insertion of markers for sections, and enforcement of length and structure constraints. The output of this step is a prompt sentence formatted for the generative AI model.

### Step 11:

Server sends the prompt sentence to the generative AI model and obtains text information.

Server uses the prompt sentence as input to a generative AI model interface. Server encodes the prompt into tokens, calls the model inference API with parameters such as maximum output length and sampling temperature, and waits for the model to generate response tokens. The model internally computes attention and feed-forward operations layer by layer, and returns generated text. Server decodes the tokens back into a text string and receives a full response. The data processing on the server side includes request composition, tokenization, parameter setting, and decoding. The output of this step is a model output text that includes explanation, alternative expressions, and a scenario for visual content.

### Step 12:

Server parses the model output text into structured sections.

Server uses the model output text as input. Server searches for section markers or patterns, such as headings “Explanation:”, “Alternatives:”, and “Video script:”. Server splits the text at these markers and assigns each section to a field in a structured object. If markers are missing, the server applies fallback rules based on paragraph breaks or keyword patterns. The data processing consists of string scanning, segmentation, and assignment to typed fields. The output of this step is a structured text information object separating explanation, alternatives, and visual scenario description.

### Step 13:

Server generates visual information from the structured text information.

Server takes the structured text information object as input to a visual content generation module. Server converts the visual scenario description into a sequence of scenes with defined durations, background types, and on-screen texts. For each scene, server maps explanation and alternative expressions to text overlays and optionally to narration scripts. Server passes this scene sequence to a video or image generation program, which renders frames, composites text, and encodes the result in a visual media format. The data processing includes assembling a timeline data structure, rendering visual elements, and encoding audio-visual streams. The output of this step is visual information, such as a video file or a set of images, stored in a machine-readable format.

### Step 14:

Server stores and prepares visual information for delivery.

Server uses the generated visual information file as input. Server writes the file to persistent storage and registers a metadata record containing the file location, associated conversation identifier, and content type. Server generates a uniform resource locator or identifier for accessing the file. The data processing includes file I/O operations, metadata insertion into a database, and creation of a reference string. The output of this step is a delivery reference that can be communicated to the terminal.

### Step 15:

Server transmits the visual information reference and summary to the terminal.

Server uses the delivery reference and the adjusted harassment determination result as input.

Server composes a response message that includes the reference to the visual information, a summary of the harassment determination, and optional textual hints. Server sends this response via the network interface to the terminal that submitted the conversation history.

The data processing consists of constructing a structured response payload and transmitting it over a communication protocol. The output of this step is a response received by the terminal that enables retrieval and presentation of the visual information.

### Step 16:

Terminal retrieves and presents the visual information to the user.

Terminal receives the response from the server as input. Terminal extracts the delivery reference and uses it to request the visual information file from the server or a storage service. After downloading the file, the terminal opens a media player or viewer and renders the video or images on the display. The data processing includes network retrieval, decoding of the media format, and scheduling of frames for display. The output of this step is a visual presentation shown to the user, including the reenacted problem portions, explanations, and alternative expressions.

### Step 17:

User reviews the visual information and provides evaluation.

User watches or views the visual information presented on the terminal as input. User assesses whether the explanations and alternatives are useful and accurate, and then operates controls on the terminal to submit evaluation, such as selecting a rating or entering comments. The data processing at the user side consists of human interpretation followed by creation of digital evaluation data, including rating values and text comments. The output of this step is user evaluation information stored temporarily in the terminal.

### Step 18:

Terminal transmits user evaluation information to the server.

Terminal uses the user evaluation information as input. Terminal packages the evaluation values, associated conversation identifier, and visual information identifier into a request payload. Terminal sends this payload to an evaluation API endpoint on the server via the network. The data processing includes serialization of evaluation fields and network transmission. The output of this step is a received evaluation request at the server.

### Step 19:

Server updates prompt generation rules and model instruction content based on evaluation.

Server receives the evaluation request as input. Server stores the evaluation data in a feedback database linked to the conversation and prompt template used. Server periodically aggregates feedback across multiple instances and computes statistics, such as average helpfulness scores for each template configuration. Server modifies prompt generation rules by adjusting parameters or selecting alternative templates to increase expected helpfulness. If the system uses learning-based rule adaptation, the server updates rule weights using the feedback as a signal. The data processing includes aggregation, statistical analysis, and rule parameter updates. The output of this step is an updated configuration of prompt sentence generation and instruction content, which influences future interactions with the generative AI model.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

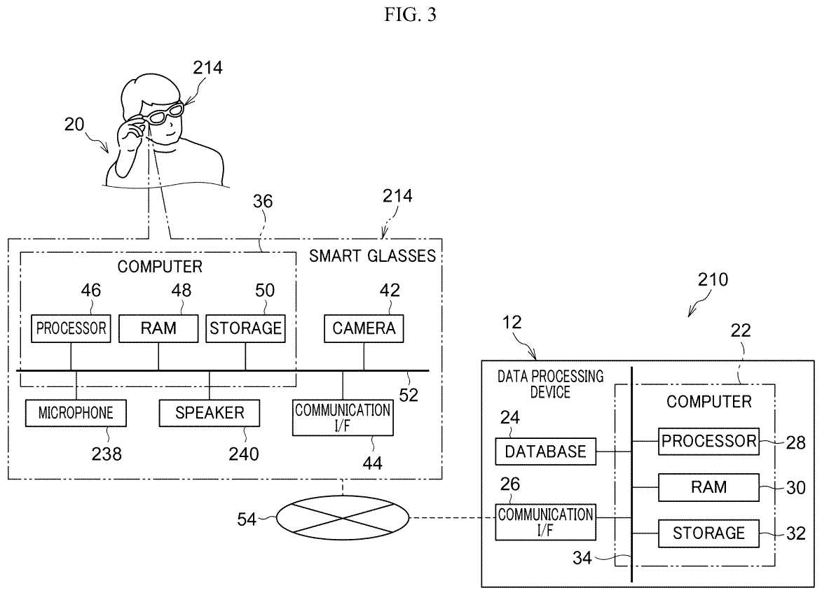

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

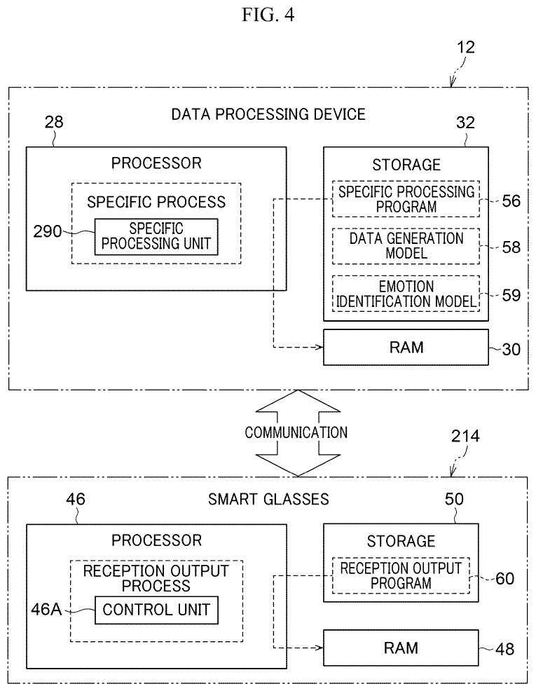

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

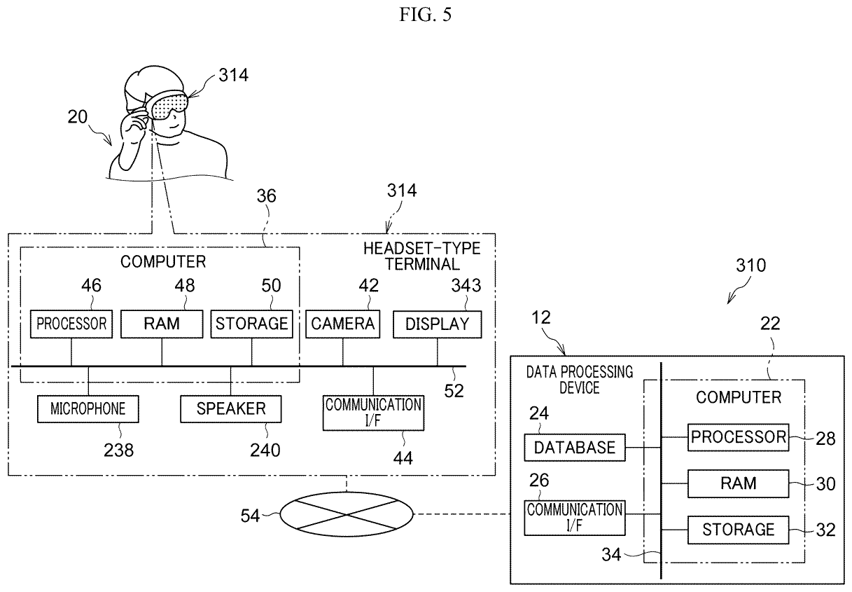

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

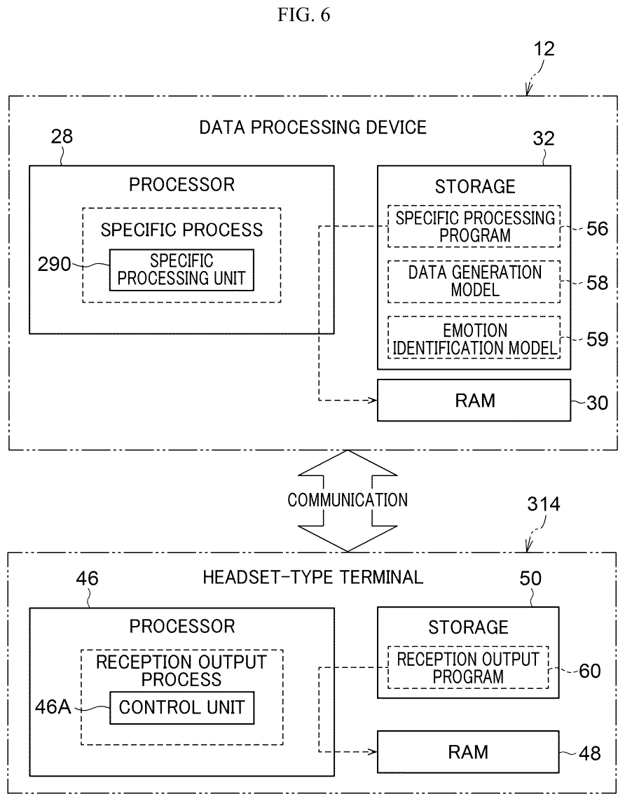

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

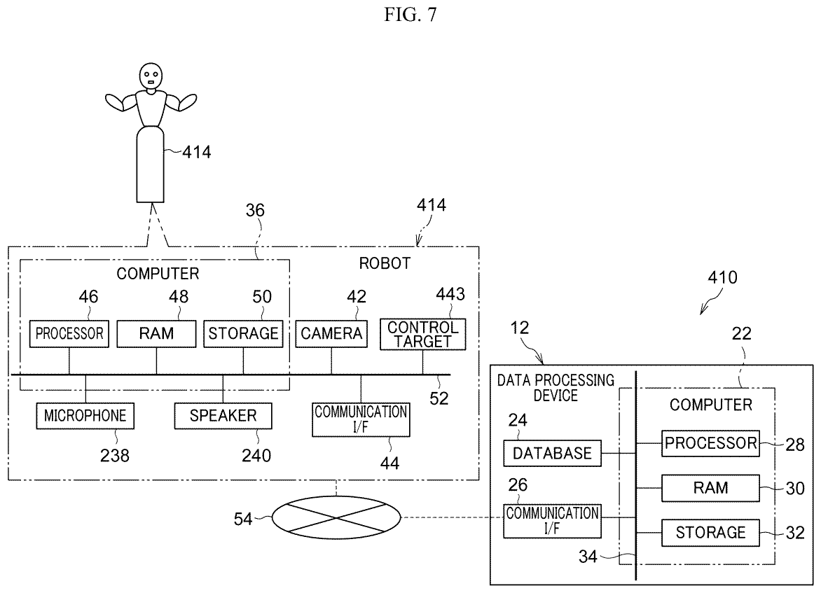

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

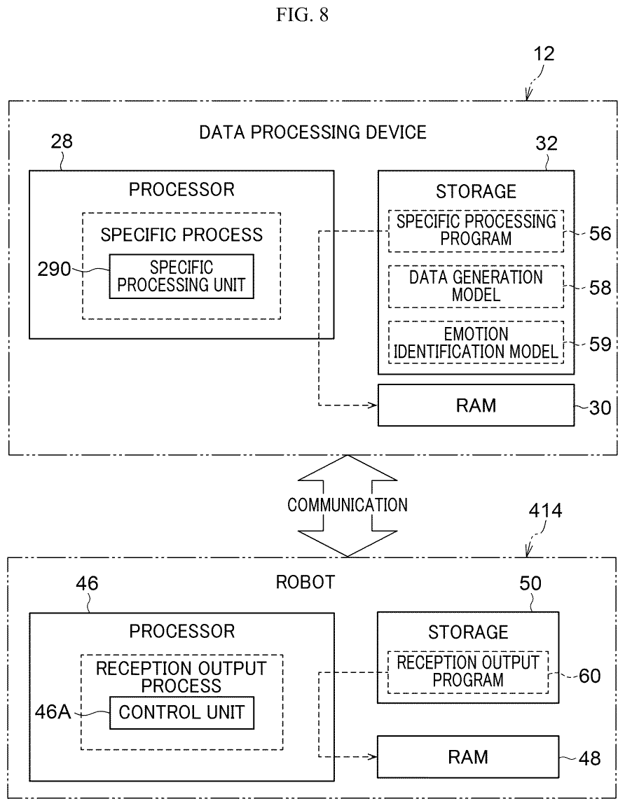

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

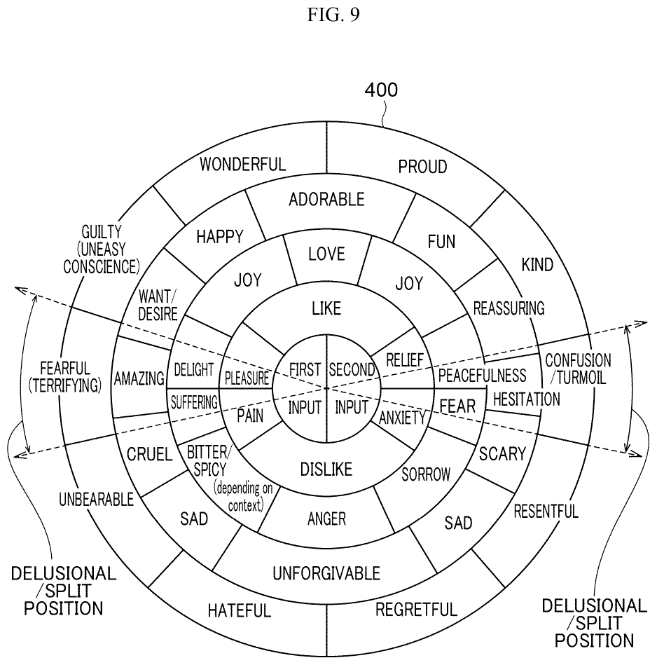

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

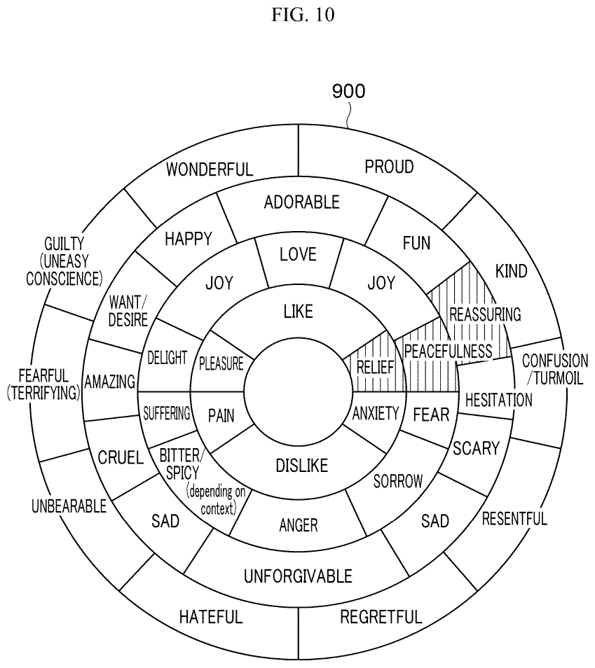

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive dialogue history data from a communication terminal and execute instructions to determine whether the dialogue history data corresponds to inappropriate behavior in human relationships,
execute instructions, by using natural language processing software, to segment the dialogue history data into units of morphemes and sentences and to generate language feature data including part-of-speech information and syntactic information,
execute instructions to convert the language feature data and a prompt sentence including an instruction sentence input by a user into numerical vector data that is inputtable to a generative artificial intelligence model operating on a deep learning framework,
execute instructions, by using the generative artificial intelligence model, to generate evaluation result data indicating presence or absence and a type of the inappropriate behavior contained in the dialogue history data, based on the prompt sentence and the dialogue history data,
execute instructions, based on the evaluation result data, to specify a portion of the dialogue history data that relates to the inappropriate behavior and to generate a prompt sentence for expressing the specification result and the evaluation result data as visual information, execute instructions to input the prompt sentence into the generative artificial intelligence model or an image generation artificial intelligence model and to automatically generate visual information indicating content and position of the inappropriate behavior, and
execute instructions to transmit the evaluation result data and the visual information to the communication terminal.

### (Supplementary 2)

The system according to supplementary 1,
wherein the processor is configured to cause the natural language processing software to extract word frequency, context information, and dependency information included in the dialogue history data, and to generate a feature vector for input to the generative artificial intelligence model by using the word frequency, the context information, and the dependency information.

### (Supplementary 3)

The system according to supplementary 1,
wherein the processor is configured to cause the generative artificial intelligence model to probabilistically classify at least one of inappropriate behavior related to imbalance of authority in human relationships and inappropriate behavior related to physical characteristics or private domains, based on expressions included in the dialogue history data, and to output a classification result and confidence information as the evaluation result data.

### Application Example 1

### (Supplementary 1)

A system comprising a processor and a memory,
wherein the processor is configured to
acquire audio information including a conversation history from a user terminal, and convert the audio information into character information by performing speech recognition
processing using an audio processing function of the user terminal or a server-side speech recognition function; and
store the character information as analysis target information in the memory, analyze the analysis target information by performing natural language processing including emotion analysis, classification analysis, and keyword extraction, calculate an evaluation value and a risk level indicating a possibility of harassment, and determine whether the conversation history corresponds to harassment on the basis of the evaluation value and the risk level; and
extract, from the conversation history determined as harassment, an utterance unit having a high possibility of harassment, generate a prompt sentence including the utterance unit, the evaluation value, and the risk level, and specify content and a format of generation information on the basis of the prompt sentence; and
input the prompt sentence into a generative information processing model, and cause the generative information processing model to automatically generate visual information including at least one of summary information, explanatory information, response policy information, and educational information relating to the conversation history; and
when the risk level is determined to be equal to or greater than a predetermined threshold, generate notification information including at least a part of the visual information and text information corresponding to the utterance unit, and transmit the notification information to a management terminal by using a communication control function; and
record, in association with each other in the memory, the analysis target information, the evaluation value, the risk level, the prompt sentence, and the visual information generated by the generative information processing model, and provide the recorded information for later viewing and aggregation processing.

### (Supplementary 2)

The system according to supplementary 1,
wherein the processor is configured to
generate the prompt sentence by ranking and selecting the utterance unit having the high possibility of harassment from the analysis target information relating to the conversation history, and by including in the prompt sentence the utterance unit, an instruction sentence for causing the generative information processing model to generate an explanation of a reason for the determination, an instruction sentence for causing the generative information processing model to generate response procedures for a manager, and an instruction sentence for causing the generative information processing model to generate examples of non-harassing expressions, and input the prompt sentence into the generative information processing model.

### (Supplementary 3)

The system according to supplementary 1,
wherein the processor is configured to
generate, as the notification information, notification data including identification information of the conversation history, excerpt text of the utterance unit, the risk level, occurrence time, and identification information for accessing the visual information, when the risk level is equal to or greater than the predetermined threshold, and perform communication control for immediate notification to the management terminal by using the notification data.

### Example 2

### (Supplementary 1)

A system comprising a processor,
wherein the processor is configured to
receive, via a communication path, evaluation target information including a dialogue history acquired from a terminal,
generate, on the basis of the received evaluation target information, a prompt sentence in accordance with generation rules, concatenate the dialogue history with the prompt sentence to generate input data, transmit a determination request including the input data to a generative AI model, and obtain a determination result and reason information indicating
whether the dialogue history corresponds to harassment,
when the determination result indicates that the dialogue history corresponds to harassment, structure educational explanation information on the basis of the dialogue history and the reason information, and generate visual content description information including the educational explanation information,
generate audio data and image data on the basis of the visual content description information, and synthesize the audio data and the image data to generate video data or interactive display data, and
manage storage location information of the generated video data or the generated interactive display data, notify the storage location information to the terminal, and cause visual information to be presented at the terminal.

### (Supplementary 2)

The system according to supplementary 1,
wherein the processor is configured to preprocess the dialogue history using natural language processing technology, adjust a number of tokens of the dialogue history on the basis of a length limitation, generate the prompt sentence including the adjusted dialogue history, and transmit the prompt sentence and model control parameters to the generative AI model.

### (Supplementary 3)

The system according to supplementary 1,
wherein the processor is configured to extract, from the dialogue history, expressions relating to power relations, inappropriate expressions, and psychological influence, classify the extracted expressions into problem utterance information, harassment reason information, and recommended countermeasure action information, generate an explanatory structure including a plurality of sections based on the classifications, and generate the visual content description information using the explanatory structure.

### Application Example 2

### (Supplementary 1)

A system comprising a processor,
wherein the processor is configured to
acquire conversation history and analyze the conversation history to determine whether the conversation history constitutes harassment, and
perform preprocessing on the conversation history and calculate harassment indicators and emotion indicators by performing language analysis including morphological analysis, syntactic analysis, and emotion analysis, and adjust a harassment determination result on the basis of the emotion indicators, and
generate a prompt sentence, on the basis of the adjusted harassment determination result and problem portions included in the conversation history, the prompt sentence including harassment content, recipient emotion, alternative expressions for improvement, and components of educational visual content, and
input the prompt sentence to a generative AI model and cause the generative AI model to generate text information including an explanation of the harassment, candidates of alternative expressions, and a scenario of visual content, and
automatically generate visual information by using a video editing program or an image generation program on the basis of the text information, the visual information reflecting problematic utterance content and the emotion indicators, and
transmit the visual information to a terminal and cause the visual information to be presented to a user.

### (Supplementary 2)

The system according to supplementary 1,
wherein the processor is configured to, when the conversation history is acquired as audio, convert the audio into text data by using a speech recognition program, and supply the text data to the language analysis.

### (Supplementary 3)

The system according to supplementary 1,
wherein the processor is configured to, on the basis of evaluation information from the user transmitted from the terminal, update generation rules of the prompt sentence and instruction content to the generative AI model, and dynamically adjust the prompt sentence so as to improve content of the visual information.

What is claimed is:

1. A system comprising:
circuitry configured to:
receive, via a communication interface coupled to a packet-switched network, input sequence data from a terminal device;
execute language analysis processing on the input sequence data to segment the input sequence data into token-level units and to generate language feature data including at least syntactic information and dependency information;
convert the language feature data and a prompt sentence into numerical vector data inputtable to a generative neural network model operating on a deep learning framework;
generate, by using the generative neural network model, classification result data indicating presence or absence of a predetermined condition in the input sequence data, together with confidence information;
specify, based on the classification result data, at least one portion of the input sequence data that contributes to the classification and generate a content generation prompt sentence for expressing the classification result data as output media data; and
transmit the classification result data and the output media data to the terminal device via the communication interface.

2. The system according to claim 1, wherein the language feature data further includes part-of-speech information, word frequency information, and context information extracted from the token-level units.

3. The system according to claim 2, wherein the circuitry is configured to generate a feature vector for each token-level unit by combining the part-of-speech information, the word frequency information, the context information, and the dependency information into a composite numerical representation inputtable to the generative neural network model.

4. The system according to claim 3, wherein the circuitry is configured to cause the generative neural network model to perform multi-class probabilistic classification on the input sequence data to output a classification label for each of a plurality of condition categories together with a probability value for each classification label, and to compute importance scores for individual token-level units based on attention weights or gradient-based measures to identify the at least one portion.

5. The system according to claim 4, wherein the plurality of condition categories includes at least a category relating to inappropriate behavior associated with an imbalance of authority in human relationships and a category relating to inappropriate behavior associated with physical characteristics or private domains.

6. The system according to claim 5, wherein the circuitry is configured to input the content generation prompt sentence into an image generation neural network model to generate the output media data as image data visually indicating content and position of the inappropriate behavior within the input sequence data.

7. The system according to claim 6, wherein the category relating to inappropriate behavior associated with an imbalance of authority in human relationships corresponds to abuse of power in a workplace, and the category relating to inappropriate behavior associated with physical characteristics or private domains corresponds to sexual harassment.

8. The system according to claim 1, wherein the circuitry is configured to acquire audio data from the terminal device via the communication interface, the audio data representing a conversation between a plurality of participants.

9. The system according to claim 8, wherein the circuitry is configured to convert the audio data into character information by performing speech recognition processing using an acoustic model and a language model, and to store the character information as the input sequence data in a storage device.

10. The system according to claim 9, wherein the circuitry is configured to compute an evaluation value for each utterance unit within the input sequence data by combining a sentiment score, a classification probability, and a keyword importance score, and to determine a risk level by comparing the evaluation value to a plurality of predetermined thresholds.

11. The system according to claim 10, wherein the circuitry is configured to generate notification data including an excerpt of an utterance unit having a highest evaluation value, the risk level, an occurrence time, and identification information for accessing the output media data, and to transmit the notification data to a management terminal device via the communication interface when the risk level is equal to or greater than a predetermined threshold.

12. The system according to claim 1, wherein the circuitry is configured to structure educational explanation information on the basis of the classification result data and reason information derived from the generative neural network model, the educational explanation information including problem utterance information, reason information for the classification, and recommended countermeasure action information.

13. The system according to claim 12, wherein the circuitry is configured to generate visual content description information from the educational explanation information, generate audio data and image data on the basis of the visual content description information, and synthesize the audio data and the image data to generate video data or interactive display data as the output media data.

14. The system according to claim 13, wherein the circuitry is configured to store the video data or the interactive display data in a storage device, manage storage location information of the stored video data or interactive display data, and transmit the storage location information to the terminal device to cause the terminal device to retrieve and present the video data or the interactive display data.

15. The system according to claim 1, wherein the circuitry is configured to compute emotion indicators by performing emotion analysis on the input sequence data, the emotion indicators representing an estimated emotional state and an intensity of the emotional state for each segment of the input sequence data.

16. The system according to claim 15, wherein the circuitry is configured to adjust the classification result data based on the emotion indicators by modifying a classification threshold or weighting when a negative emotion intensity for a segment exceeds a predetermined value, to generate an adjusted classification result.

17. The system according to claim 16, wherein the circuitry is configured to receive user evaluation information from the terminal device indicating an assessment of the output media data, and to update generation rules of the prompt sentence and instruction content provided to the generative neural network model based on the user evaluation information.

18. A system comprising:
circuitry configured to:
receive, via a communication interface coupled to a packet-switched network, input sequence data from a terminal device, and execute language analysis processing including tokenization, morphological analysis, syntactic parsing, and dependency analysis on the input sequence data to generate language feature data including part-of-speech information, syntactic information, word frequency information, context information, and dependency information;
convert the language feature data and a prompt sentence including an instruction sentence into numerical vector data by combining token embeddings with feature encodings derived from the language feature data, the numerical vector data being inputtable to a transformer-based generative neural network model comprising a plurality of self-attention layers and feed-forward layers;
generate, by using the transformer-based generative neural network model, classification result data including a multi-class classification label, a probability value for each class, and importance scores for individual token-level units computed from attention weights, the classification result data indicating presence or absence and a type of a predetermined condition in the input sequence data;
specify, based on the importance scores, at least one portion of the input sequence data that contributes to the classification, generate a content generation prompt sentence including the at least one portion and the classification result data, and input the content generation prompt sentence into an image generation neural network model to generate output media data visually indicating content and position of the predetermined condition; and
transmit the classification result data and the output media data to the terminal device via the communication interface.

19. The system according to claim 18, wherein the transformer-based generative neural network model is trained using a multi-task learning strategy that combines a cross-entropy loss for the multi-class classification label with a sequence generation loss for producing explanation text, and the circuitry is configured to generate the explanation text as part of the classification result data.

20. A method performed by circuitry of a system coupled to a packet-switched network via a communication interface, the method comprising:
receiving, via the communication interface, input sequence data from a terminal device;
executing language analysis processing on the input sequence data to segment the input sequence data into token-level units and to generate language feature data including at least syntactic information and dependency information;
converting the language feature data and a prompt sentence into numerical vector data inputtable to a generative neural network model operating on a deep learning framework;
generating, by using the generative neural network model, classification result data indicating presence or absence of a predetermined condition in the input sequence data, together with confidence information;
specifying, based on the classification result data, at least one portion of the input sequence data that contributes to the classification and generating a content generation prompt sentence for expressing the classification result data as output media data; and
transmitting the classification result data and the output media data to the terminal device via the communication interface.
